(19) United States
(12) Patent Application Publication
(10) Pub. No.: US 2019/0098004 A1
(43) Pub. Date: Mar. 28, 2019

(54) UNIVERSAL ID SYSTEM AND METHODS AND BIOMETRIC INFORMATION

(71) Applicant: Proxy Technologies, Inc., San Francisco, CA (US)

(72) Inventors: Denis Mars, San Francisco, CA (US); Simon Ratner, San Francisco, CA (US)

(21) Appl. No.: 16/164,822

(22) Filed: Oct. 19, 2018

Related U.S. Application Data
(63) Continuation-in-part of application No. 16/129,901, filed on Sep. 13, 2018.
Application No. 16/129,901 is a continuation-in-part of application No. 16/129,859, filed on Sep. 13, 2018.
Application No. 16/129,859 is a continuation-in-part of application No. 15/716,464, filed on Sep. 26, 2017.
(60) Provisional application No. 62/685,292, filed on Jun. 15, 2018.

(51) Int. Cl. H04L 29/06

(52) U.S. Cl. CPC H04L 63/0861; H04L 63/0876

(57) ABSTRACT

A method is provided of conducting an interaction between a first entity and a second entity. A Universal ID system includes a front end with a transmitter, a receiver coupled to the transmitter and at least one passive filter coupled to the transmitter. The front-end is coupled to at least one of a back-end or a cloud system. Each of the back-end and the cloud system includes: storage; server; a Universal ID character generator device that generates portions of the Universal ID. In response to an interaction between the first entity and a second entity he transmitter transmits a signal for all or a portion of a first entity Universal ID that includes non-permanent IDs and permanent IDs. The Universal ID includes and/or is layered with biometric identifiers of the first entity. The signal includes a plurality of authentications with identifiers. Each of an authentication associated with a different second entity. The first party Universal ID is used with a plurality of electronic devices that each have a different first entity authentication from the Universal ID with each of a different electronic device requiring a first entity authentication to gain access to each of an electronic device of the plurality of electronic devices. The signal provides an authentication of the Universal ID to a second entity and is done passivity where the first entity takes no action for the first entity Universal ID signal to be emitted, and for an interaction to be sensed and acted on by an action, in response to the interaction the second entity creates an action that causes a physical change in a hardware component of a second entity electronic device.

### CROSS-REFERENCE TO RELATED APPLICATIONS

This application is a Continuation-In-Part of Ser. No. 16/129,901, filed on Sep. 13, 2018, which is a Continuation-In-Part of Ser. No. 16/129,859, filed on Sep. 13, 2018, which claims priority from U.S. Provisional Patent Application No. 62/685,292, filed on Jun. 15, 2018, which is incorporated herein by reference.

### BACKGROUND

### Field of the Invention

This invention is directed to authentications for devices, and more particularly to systems, devices, methods that provide a Universal ID/Identification without centrally or locally storing an entities biometric information on a third-party infrastructure.

### Description of the Related Art

Current methods to create a Universal Identification (ID) signal for an entity have involved frameworks or underlying models in which the burden of implementing the signal-broadcasting it and ensuring that devices detect it and this rests on the entity. This task of creating a personal signal or what is sometimes referred to as a transponder or signal that can be picked up by a wide array of devices in varying environments or physical spaces is, not surprisingly, typically beyond the technical domain of most regular entities. This is one of several barriers that has prevented the growth of a truly Universal ID for entities, universal in the sense that a signal is not tied or detectable only to a specific manufacturer, social media or network provider, or company.

There are some implementations for authentication that leverage one online identity or profile to interact with various types of devices. Besides the security and data control/privacy concerns this raises, such single online personas do not truly reflect how entities behave or act in the real, physical world. Human interactions with physical environments have developed over millennia, as such, it should not be expected that this behavior be reflected in online personas.

Other factors that have prevented universal authentication from widespread adoption include generally a lack of motivation from manufacturers and companies to create their own apps, portals, back-end infrastructure, secure element hardware, and so on, that would be needed to implement a signal or signal framework with their customers. Again, this leads to a siloed approach that is simply not worth the expense and maintenance for many entities.

In a world where more and more devices are including capabilities of facial recognition and voice recognition to be able to identify a person, just by walking up to things or talking to things, there needs to be a way to do this without having everyone's biometric information stored in millions of databases everywhere both on servers and on the devices themselves whereby they become targets for hackers to steal. When you lose a credit card the bank can be called to issue a new credit card. However, when biometric information is stolen there is no one to call to replace the lost or stolen biometric information. This is a major problem when electronic devices, security cameras, public infrastructure, machines, consumer electronics and websites and the like collect and store this type of information creating millions of points of attack for hackers to steal our personal biometric data.

There is a need to sense an entities physical presence, and to identify that entity passively in the physical environment. This can be achieved using a camera for facial recognition, a microphone for a voice recognition, and the like. This provides that no face or voice markers or biometric information is stored on a local or centralized server and reduces or eliminates biometric information being stolen by hackers.

### SUMMARY

An object of the present invention is to provide systems, methods and devices that sense an entities physical presence, and passively identifies that entity in the physical environment.

Another object of the present invention is to provide systems, methods and devices that reduce the problem of biometric information of an entity being stolen.

Yet another object of the present invention is to provide systems, methods and devices that do not store an entities biometric information on a centralized server and reduces or eliminates biometric information being stolen by hackers.

These and other objects of the present invention are achieved in a method of conducting an interaction between a first entity and a second entity. A Universal ID system includes a front end with a transmitter, a receiver coupled to the transmitter and at least one passive filter coupled to the transmitter. The front-end is coupled to at least one of a back-end or a cloud system. Each of the back-end and the cloud system includes: storage; server; a Universal ID character generator device that generates portions of the Universal ID. In response to an interaction between the first entity and a second entity he transmitter transmits a signal for all or a portion of a first entity Universal ID that includes non-permanent IDs and permanent IDs. The Universal ID being includes biometric identifiers of the first entity. The signal includes a plurality of authentications with identifiers. Each of an authentication associated with a different second entity. The first party Universal ID is used with a plurality of electronic devices that each have a different first entity authentication from the Universal ID with each of a different electronic device requiring a first entity authentication to gain access to each of an electronic device of the plurality of electronic devices. The signal provides an authentication of the Universal ID to a second entity and is done passivity where the first entity takes no action for the first entity Universal ID signal to be emitted, and for an interaction to be sensed and acted on by an action, in response to the interaction the second entity creates an action that causes a physical change in a hardware component of a second entity electronic device.

In another embodiment of the present invention, a method is provided of conducting an interaction between a first entity and a second entity. A Universal ID system includes a front end with a transmitter, a receiver coupled to the transmitter and at least one passive filter coupled to the transmitter. The front-end is coupled to at least one of a back-end or a cloud system. Each of the back-end and the cloud system includes: storage; server; a Universal ID character generator device that generates portions of the Universal ID. In response to an interaction between the first entity and a second entity he transmitter transmits a signal for all or a portion of a first entity Universal ID. The Universal ID being includes with biometric identifiers of the first entity. The signal includes a plurality of authentications with identifiers. Each of an authentication associated with a different second entity. The first party Universal ID is used with a plurality of electronic devices that each have a different first entity authentication from the Universal ID with each of a different electronic device requiring a first entity authentication to gain access to each of an electronic device of the plurality of electronic devices. The signal provides an authentication of the Universal ID to a second entity and is done passivity where the first entity takes no action for the first entity Universal ID signal to be emitted, and for an interaction to be sensed and acted on by an action, in response to the interaction the second entity creates an action that causes a physical change in a hardware component of a second entity electronic device. The first entity Universal ID signal is sensed passively, decoded in a background and provided by the second entity, recognized and authenticated without requiring dedicated secure element hardware within the first or the second entity.

### BRIEF DESCRIPTION OF THE DRAWINGS

FIG. 1 illustrates one embodiment of a system 10 for creating the Universal ID.

FIG. 2 illustrates one embodiment of the Universal ID where it can be a word or string of characters used for an entity authentication to prove identity to gain access to an electronic device.

FIG. 3 is one example of a process that can be used in one embodiment of the present invention.

FIG. 4 is one example of a physical environment showing different types of electronic devices and entities.

FIG. 5 is one example of a block diagram showing three primary components to create the Universal ID.

FIG. 6A is one example of an entity joining a Universal ID signal framework.

FIG. 6B is one example of a flow diagram for a process of registering and initializing an electronic device so that it can be a Universal ID signal sensing device in a physical space in accordance with one embodiment;

FIG. 7 is one example for process of passive detection of the Universal signal.

FIG. 8 is one example for a process of transmitting the Universal ID signal.

FIG. 9 is one example for a process of operations that occur on the electronic device when the electronic device is online.

FIG. 10 is one example for a process that occurs on the device when the electronic device is offline.

FIG. 11 is one example computer system capable of implementing various processes of the present invention.

FIGS. 12A-E illustrate one embodiment of a back-end for the Universal ID system.

FIGS. 13-15 illustrate one embodiment of an electronic device that is a mobile device.

### DETAILED DESCRIPTION

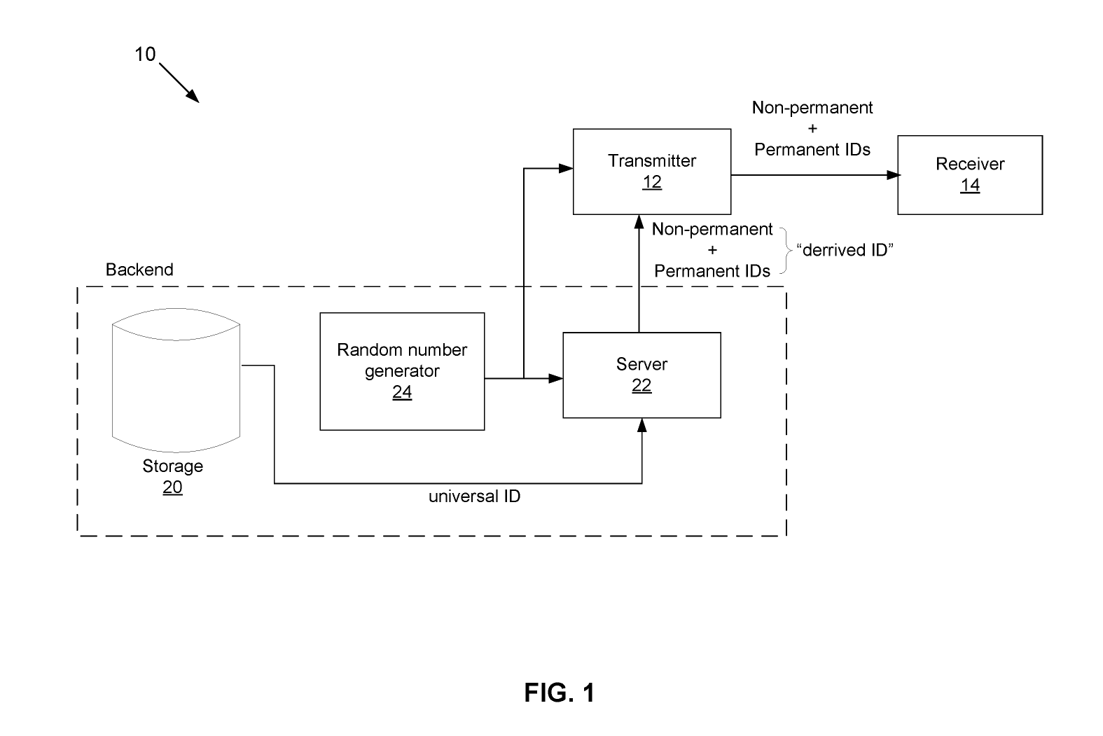

FIG. 1 illustrates one embodiment of a system 10 for creating the Universal ID. System 10 includes a front-end that includes at least the following: transmitter 12 that transmits all or a portion of a Universal ID, including non-permanent and permanent ID of an entity to a receiver 14. One or more passive filters 16 can be included. Transmitter 12 communicates with receiver 14 by a variety of different mechanisms, including but not limited to: radio; ultrasound; light/visual; direct electrical; one or more Network Systems; and the like.

In one embodiment the front-end is coupled to a back-end that includes: storage 20; server 22; a Universal ID character generator device 24 (hereafter “character generator device 24”) that generates portions of the Universal ID. Character generator device 24 is used to generate different IDs. Generation of the Universal ID can be random, non-random, time bound, location bound and the like. As a non-limiting example, character generator device 24 can be a random number generator 24, any other equivalent; and the like. System 10 also includes circuitry 26.

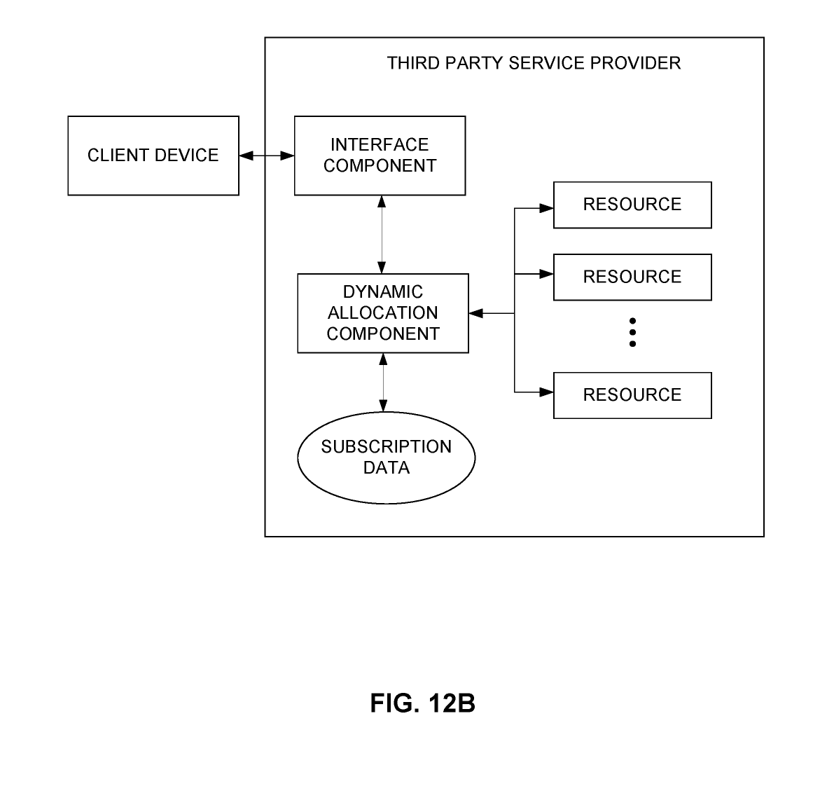

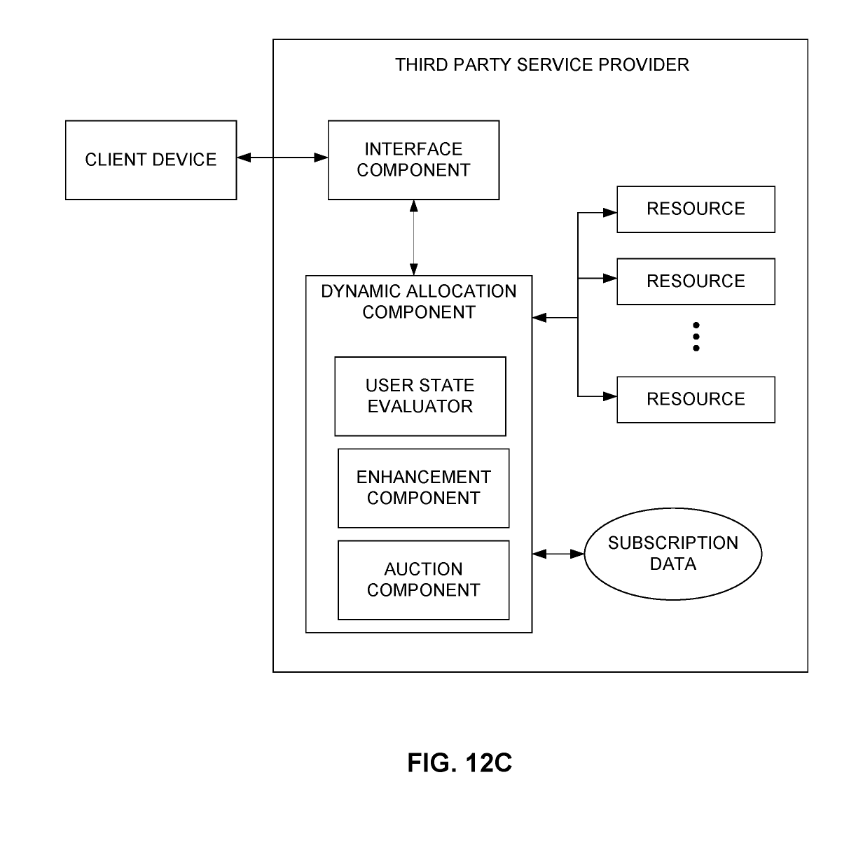

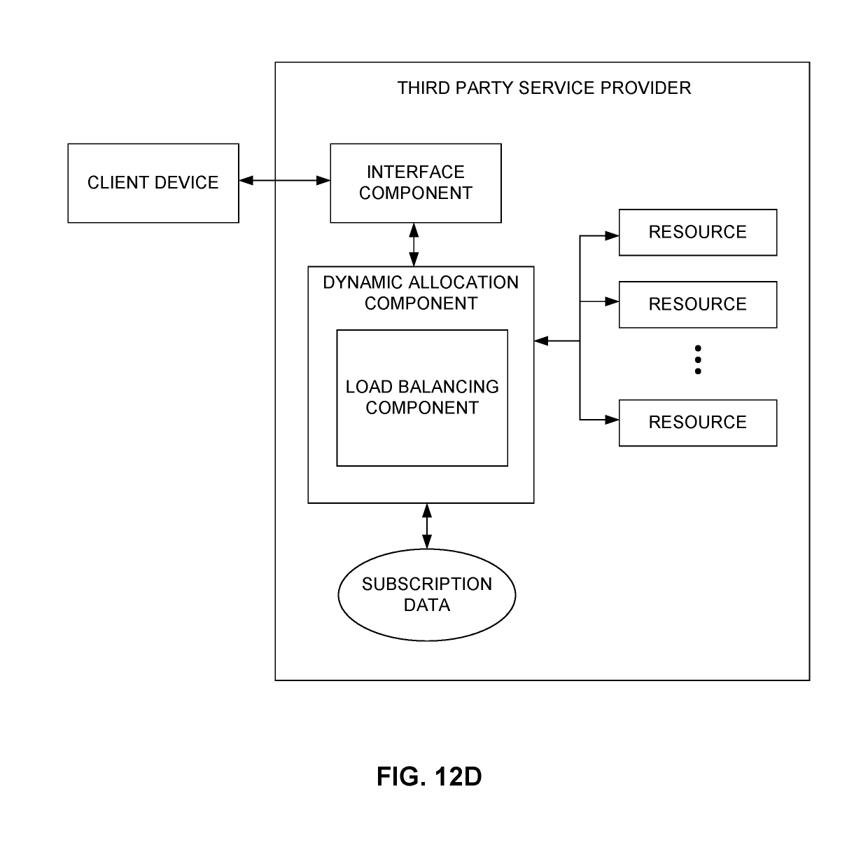

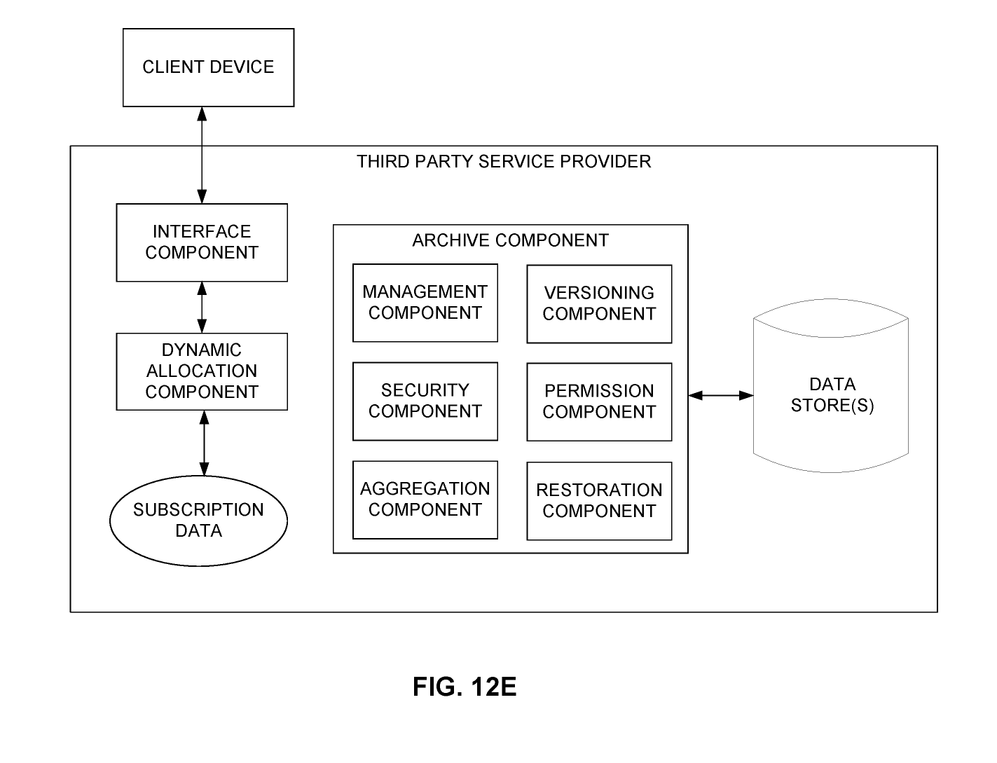

In another embodiment the front-end is in communication with a cloud system, such as that illustrated in FIG. 12.

In one embodiment the Universal ID is dynamic and is for a single entity. As a non-limiting example, a Universal ID signal is emitted from an electronic device as an object in physical space. As non-limited example, the electronic device requires authentication of an entity.

As a non-limiting example, the first entity Universal ID includes a plurality of specific first entity app ID's that collectively form the first entity Universal ID.

In one embodiment the Universal ID includes a plurality of numbers, symbols, identifiers, biometric information and the like.

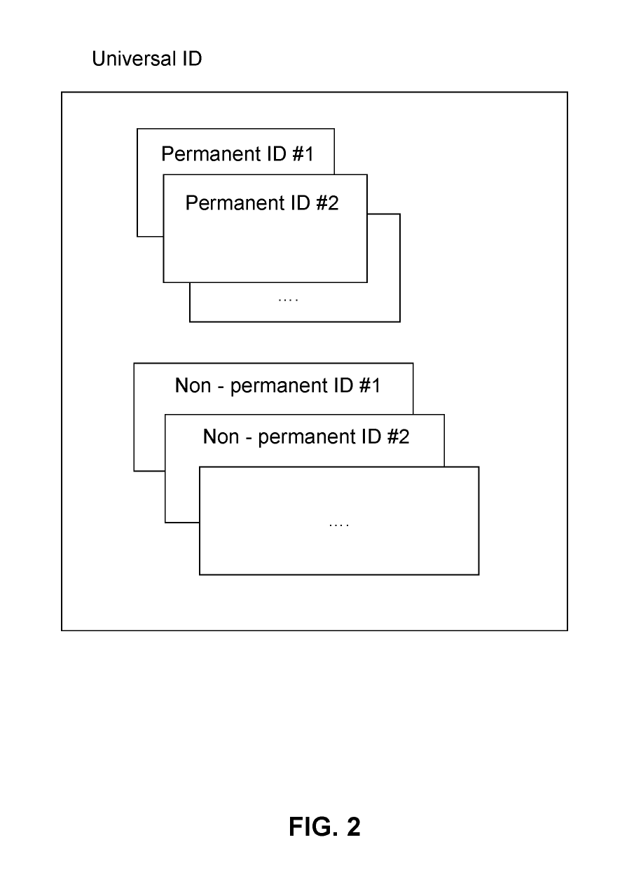

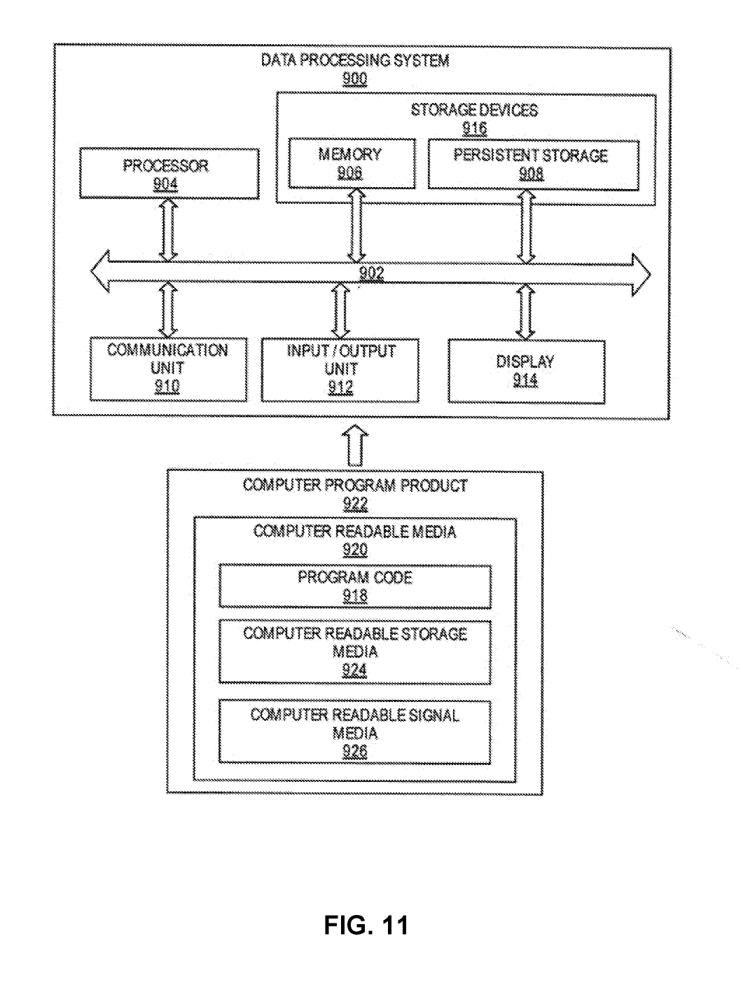

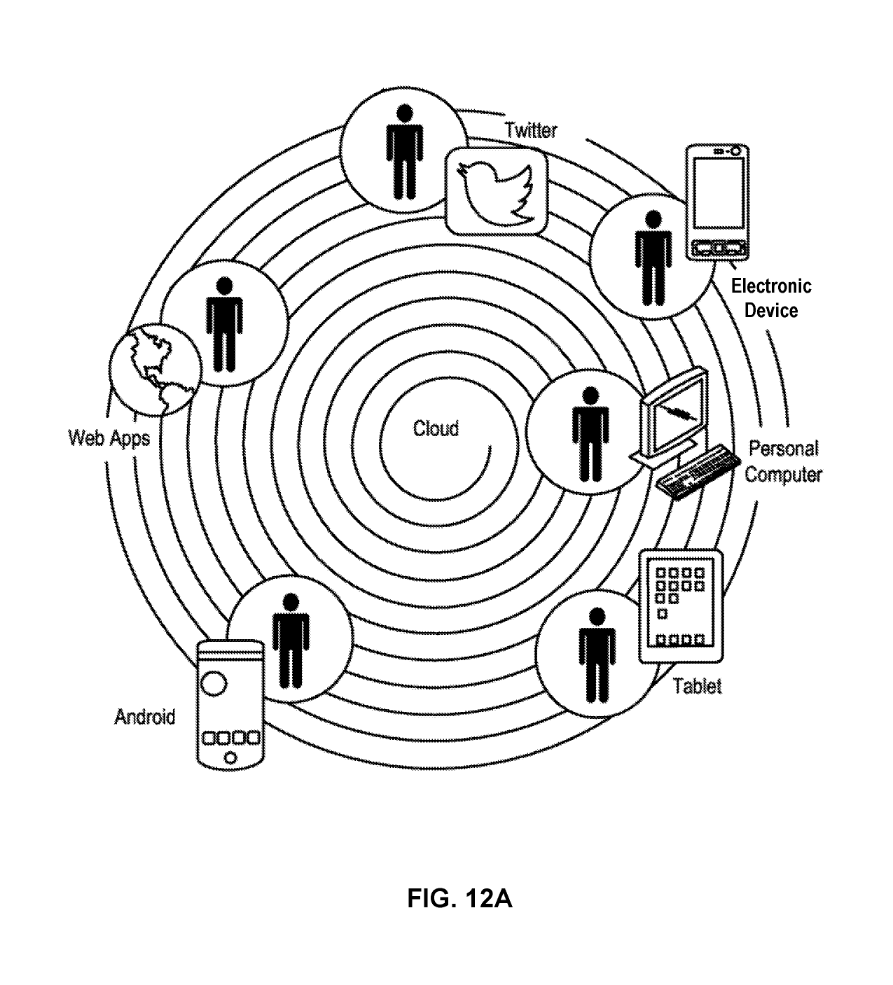

Referring to FIG. 2, and as a non-limiting example, the Universal ID can be a word or string of characters used for an entity authentication to prove identity to gain access to an electronic device, system or resource, and methods associated there. The Universal ID is used with multiple electronic devices, more particularly to electronic devices that require authentication. In one embodiment the device is an electronic device with a plurality of hardware elements, including but not limited to those disclosed in FIG. 11. The electronic device typically also includes software. As a non-limiting example, the electronic device is a mobile device.

In one embodiment systems, methods of use and electronic devices are provided with a personal Universal ID, hereafter “Universal ID”. The Universal ID allows for an entity to identify and interact with a variety of physical world electronic devices or objects by different creators, manufacturers, and the like, in a manner that allows for strict data control, security, and privacy. A physical world device or object is something present and interactive that in response to receipt of the Universal ID, or a portion of it, transmits a first entity's ID, via authentication, in order to interact with a second entity device that causes an action to be taken. In one embodiment the Universal ID is used to query a signal for all or a portion of an entities preferences. As non-limiting examples, these can include but are not limited to an entity's preference for: room temperature, coffee, car seat position, lighting preferences, and the like.

In one embodiment the Universal ID provides authentication of an entity including but not limited to: passwords/passcodes, physical recognitions such as an entities biometric parameter, including but not limited to: biometric identifiers are the distinctive, measurable characteristics used to label and describe individuals. In one embodiment biometric parameters include identifiers that can be both physiological and behavioral characteristics. As a non-limiting example, physiological characteristic is related to the shape of the body. Non-limiting examples include, but are not limited to: fingerprint, palm veins, face recognition, DNA, palm print, hand geometry, iris recognition, retina, odor/scent, and the like. Behavioral biometric characteristics are related to the pattern of behavior of a person, including but not limited to typing rhythm, gait, voice, gestures and the like. As a non-limiting example, a Universal ID can for any number of that an entity has, and also allows for a second entity, with permissions by the first entity, to use all or a portion of the first entities electronic devices to create an action.

As non-limiting examples, the interactions between entities include but are not limited to: manage personal information including notes, calendar and to-do lists; communicate with laptop or desktop computers; sync data with applications like Microsoft Outlook® and Apple® iCal calendar programs; host applications such as word processing programs or video games; scan a receipt; cash a check; replace the wallet; unlock/lock cars, unlock/lock electronic devices; store credit card information and discount or membership card information; pay bills by downloading apps such as PayPal® and CardStar®; create a WiFi network that multiple electronic devices can use simultaneously.

In one embodiment, when the action is taken there is a physical change in a hardware element. As non-limiting examples the Universal ID and connections between first, second, third, and the like entity electronic devices, that can result in physical changes to one or more of: circuits; power sources, relays; change the way a device transmits images, radio power systems, and the like.

Non-limiting examples of electronic devices or objects include but are not limited to an entity's: mobile electronic device; neural links that lay on your brain; neural links coupled to a processor, server, mobile device, computer and the like; wearable devices; a human microchip implant that can be an identifying integrated circuit device or RFID transponder encased in silicate glass and implanted in the body of a human being; artificial intelligence (“AI”) agents coupled LO devices; cloud based devices; standalone augmented reality devices such as headsets; human machine fusion; connected cars; smart home speakers; advanced imaging devices; appliances and components in homes, cars, offices and the like, merchant systems and components, financial institutions and entities, systems for transfers of data, systems for transfer of money. As a non-limiting example, a first entity's device can communicate with a second entity's device in order to initiate an action that the second entity's device performs or takes. As a non-limiting example, first and second entity devices are not bundled.

In one embodiment the Universal ID provides control relative to who has access to a device, system and the like of an entity. In one embodiment this enables an entity to control who can exchange an identifier for another identifier relative to a device.

As a non-limiting example, this is achieved by: (i) having two levels of identifiers; and (ii) allowing an entity to change the identifiers at will.

In one embodiment to create a Universal ID an entity can send all or just a portion of its identifiers to system 10 at the same time, at different times, on demand, each time an entity supplies an identifier. In one embodiment, this can also be on demand. In one embodiment when an entity uses an identifier it can supplied to system 10. In one embodiment when a second entity asks for a first entity's identifier(s) system 10 creates a different identifier for the first entity and then the second entity asks the first entity to confirm this new identifier. In one embodiment to create the Universal ID not everything needs to be done at the same time.

As a non-limiting example, the first entity Universal ID is a passive signal that is secure, maintains privacy, and provides the first entity Universal ID as a protocol to exchange information to a desired second entity. In one embodiment the protocol is a physical world interaction. The first entity Universal ID never leaves the entities device, the cloud or the back-end.

Non-limiting examples of the first entity include but are not limited to: a human, robot, electronic personal assistants, and the like.

The first entity Universal ID signal can be a collection of numbers, symbols, fingerprints, facial pattern, letters, and anything that can be used in an identification.

As a non-limiting example, an entity includes but is not limited to: humans; groups of humans; robots, electronic personal assistants, organizations; business entities, and the like.

In one embodiment transmitter 12 communicates all or only a portion of an entity's Universal ID, including but not limited to: permanent and non-permanent ID's.

The Universal ID is used to provide connections between a first entity through any one of the first entities electronic devices to second entity electronic devices. The Universal ID is used to provide connections between electronic devices between a first entity through a second entity, third fourth and fourth entities, and so on, with associated electronic devices. In various embodiment the generation of a Universal ID occurs in the cloud, as more fully discussed hereafter, back-end, and the like. In one embodiment the Universal ID is modifiable. The Universal ID includes a plurality of non-permanent ID and permanent ID's. The non-permanent ID has some type of limitation. As non-limiting examples the limitation includes but is not limiting to; the amount of time that it exists; the number of times it can be used; space/location limitations; the number of entities associated with it, and the like. The permanent ID does not include all of the limitations of the non-permanent ID. In one embodiment the non-permanent ID expires by itself and has a shorter duration than the permanent ID. In one embodiment a permanent ID expires when the entity represented by the permanent ID decides to change it and/or eliminate it. In the FIG. 2 embodiment the Universal ID includes a permanent ID for the first entity and a permanent ID for a second entity. Any number of entities can be included. The Universal ID has a non-permanent ID for the first entity, one for the second entity, and so on for other entities.

In one embodiment algorithms are used to generate the permanent and non-permanent ID's. As a non-limiting example, the permanent and non-permanent ID's can be one or more of: random; random with time ordering; random with location binding; non-random, hash derived from first, second, third, etc. entities with unique values under a first entity, and the like.

In one embodiment a variety of algorithms are used. As a non-limiting example, one or more algorithms are provided for passivity and authentication.

As non-limiting examples computer system executes one or more of the following types of algorithms: anomaly detection; signal filter; a Kalman filter; alpha-beta; averaging; infinite impulse response (“IIR”); and the like

In one embodiment system 10 receives information from an entity that includes receiving all or a portion of that entities authentications for interactions with electronic devices, both its own as well as those of second, third, fourth parties, etc. As a non-limiting example, the Universal ID can include more than 50%, 50-60%, 70-80%, 80-90%, 80-95% and 95-100% of an entities authentication.

In one embodiment an identify resolution algorithm is used for authentications, e.g., non-permeant IDs, as a non-limiting example, this provides a way to make a Universal ID, such as a first entity Universal ID, signal private. Later the first entity Universal ID signal is resolved to a carrier identifier. As a non-limiting example, the first entity Universal ID takes one of its identifiers and continues to change non-permanent IDs. As a non-limiting example, on the sensing side the first entity Universal ID takes the identifier and uses the first's entities agent to resolve it into useful information, with the second entity then having knowledge about the first entity. The second entity captures only one version about the identifier. The second entity asks the Universal ID apparatus/system about the non-permanent identifier. Non-permanent IDs are different for each second entity. The non-permanent identifiers are part of the first entity Universal ID, the first entity Universal ID provides a plurality of non-permanent identifiers. Because they change all the time.

As a non-limiting example, in a first step the non-permanent ID is broadcast. In one embodiment all or a portion of the non-permanent IDs remained unchanged. In another embodiment all or a portion of the non-permanent IDs constantly change. In one embodiment the non-permanent IDs change at different rates.

As a non-limiting example, in a second step the second entity receives the non-permanent ID and then interacts with the field of influence for interaction, and then interacts with a back-end or the cloud to ask for more information. The first entity Universal ID provides a non-permanent ID for this interaction. Each second entity has at least one non-permanent ID that is a unique identifier which is thereafter the same ID for that second entity. This enables the second entity to be a correlator. In one embodiment an entity can have more than one non-permanent ID.

As a non-limiting example, a first entity Universal ID provides a field of influence for interaction that is emitted as a first entity Universal ID signal within a limited range proximity can be in miles, feet and the like. As a non-limiting example, the range proximity is between 0 and up to 20 feet.

In one embodiment artificial intelligence “AI” uses a first entity Universal ID signal to provide a field of influence for interaction.

The field of influence for interaction enhances AI for entities, and allows entities to identify and interact with a variety electronic device by different manufacturers in a manner that allows for strict data control, security, and privacy.

In one embodiment of AI field of influences each first entity has its own personal agent, which can be an AI agent.

In one embodiment the field of influence for interaction exchanges Universal ID information, and/or a portion of the Universal ID, preemptively ahead of any interactions. In this manner the field of influence for interaction conducts pre-filtering or pre-authorization. As a non-limiting example this is done before the first entity begins any interaction and the second entity interaction is done ahead of time. In this manner the resolution of the identification and authorization for information exchange is done ahead of time without the first entity being aware of the second entity. This is done with any wireless protocols. This can occur if the desired second entity location is farther away than a second entity that is closer in proximity to the first entity.

In one embodiment the field of influence for interaction performs an ID preauthorization of information to reduce perceived time of interaction.

In one embodiment the field of influence for interactions reduces a perceived distance of interaction, e.g. space, by exchanging information between the same second entity at a first location that is closer than a second location, where the first entity is going to interact with the second location between like second parties.

As a non-limiting example, the field of influence for interaction hides stretches of time by resolving ID ahead of time, and then the field of influence for interaction pre-authorizes the information. As a non-limiting example, the field of influence for interaction hides distances of space by allowing like second parties to propagate first entity information before the first entity is in range of the desired second entity. As a non-limiting example this is done in a secure manner and can be achieved with the field of influence for interaction sending tokens or commands that are encrypted or authenticated. As a non-limiting example this can be done by the first entity or back-end.

As a non-limiting example, in a third step a second entity permanent ID allows the second entity to take an action in order to have function plus correlation.

As a non-limiting example, in a fourth step the first entity can cause the second entity to forget the non-permanent ID. In this manner the first entity stops the second entity from correlating current events from past events. As a non-limiting example, this can be achieved the next time and the second permanent ID as a different one. At this time the second entity perceives the first entity to be a new first entity

In one embodiment the first entity Universal ID provides for a physical world augmentation. The augmentation it is not a virtual world.

Augmentation makes second entity interactions smarter. As a non-limiting example using the first entity Universal ID the first entity is augmented passively with a second entity without requiring any action on the part of the first entity. The Universal ID signal of the first entity is sensed passively, decoded in the background functionally provided by the second entity, recognized and authenticated. Passivity is where the first entity takes no action for the first entity Universal ID signal to be emitted, and for an interaction to be sensed and acted on by an action. As non-limiting examples, passivity: (i) allows for pre-authorization ahead of time; and being smart relative to how the signal is detected. A second algorithm is utilized and directed to passivity, e.g. exchanging ID information in a passive way without a Universal ID entity having to take an action. Instead, system 10 takes and performs the required action.

Passivity enables automation, where automation is a collection of data and events to be performed for an entity. As a non-limiting example, with passivity detective, the first entity signal is previously detected and now that that it has been detected it is then correlated with another event. As a non-limiting example there are some intent triggers that occur when some intent in shown. As a non-limiting example automation is one option indicative of intent for some action to be taken. As non-limiting examples for some actions the intent can be determined by at least one of: facial, voice, gestures, proximity, and the like.

As a non-limiting example, the personal agent is a dynamic ID because it is a dynamic first entity Universal ID and provides identification in response to how it is asking.

In one embodiment each or all of the first entity's app IDs is a dynamic presentation of a portion of the first entity Universal ID. As a non-limiting example, the first entity Universal ID can be dynamic for every interaction.

In one embodiment the first entity Universal ID solves the problem of each app having a specific identity. As a non-limiting example, the first entity Universal ID is a single ID for all apps.

### Example 1

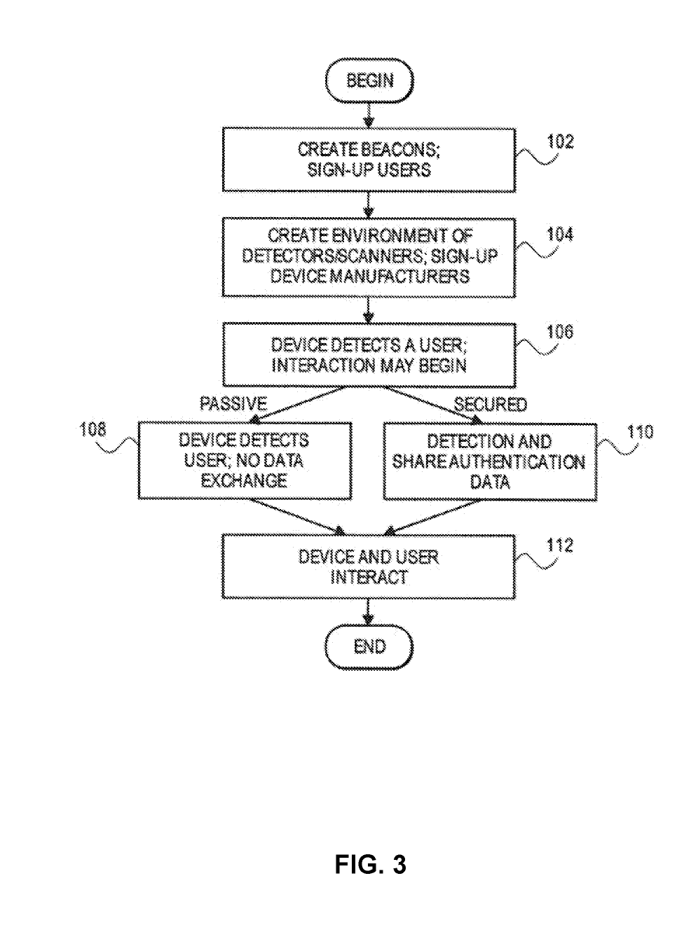

FIG. 3 is an example of how an entity operates with the system 10. At step 102 an entity operates as a transmitter and moves around in a physical space. At step 104 an environment or space in which an electronic device operates is created. At step 106 the electronic device of a first entity detects a signal from system 10 in response to an initial interaction between the first entity electronic device and a second entity electronic device.

The initial interaction can be a passive interaction shown in step 108. Here the first party electronic device detects the presence of a signal. The device may not determine the identity of the entity, that is, the entity remains anonymous. In another passive mode embodiment, the entity may be identified but only in by back-end or the cloud and not on the electronic device itself. As a non-limiting example, the server may be accessible without a Network System connection or being online (e.g., via Ethernet, Zigbee, and the like). This passive scanning or detecting presence of an electronic device may be useful in various contexts, including but not limited to: counting the number of people in a room or space, or whether someone just walked into a space. As a non-limiting example, the electronic device wants to sense entities around it, but the entity dictates the privacy. As a non-limiting example, the entity is a gatekeeper on its identity. The electronic device that detects or sense the presence of the entity may interact, it may do something, but that action does not have privacy concerns or require entity authorization, hence, the passive nature of the interaction.

In one embodiment, an interaction can be a secured exchange where there is authentication of the entity shown in step 110. As non-limiting examples tokens, command and the like authenticate and a first entity electronic device can make authorization requests. In one embodiment, tokens, commands and the like are used to prove that the entity is authorized. The first entity electronic device signal has at least one signed token or command from a server at back-end or the cloud that authenticates the entity to the first party electronic device 18. Once this authentication is made, the first entity electronic device will perform the relevant action and interact with the second entity. As a non-limiting example, in either passive or secured exchange scenarios, the first entity electronic device may interact with a second entity electronic device entity as shown in step 112, but the level or degree of interaction will naturally vary.

### Example 2

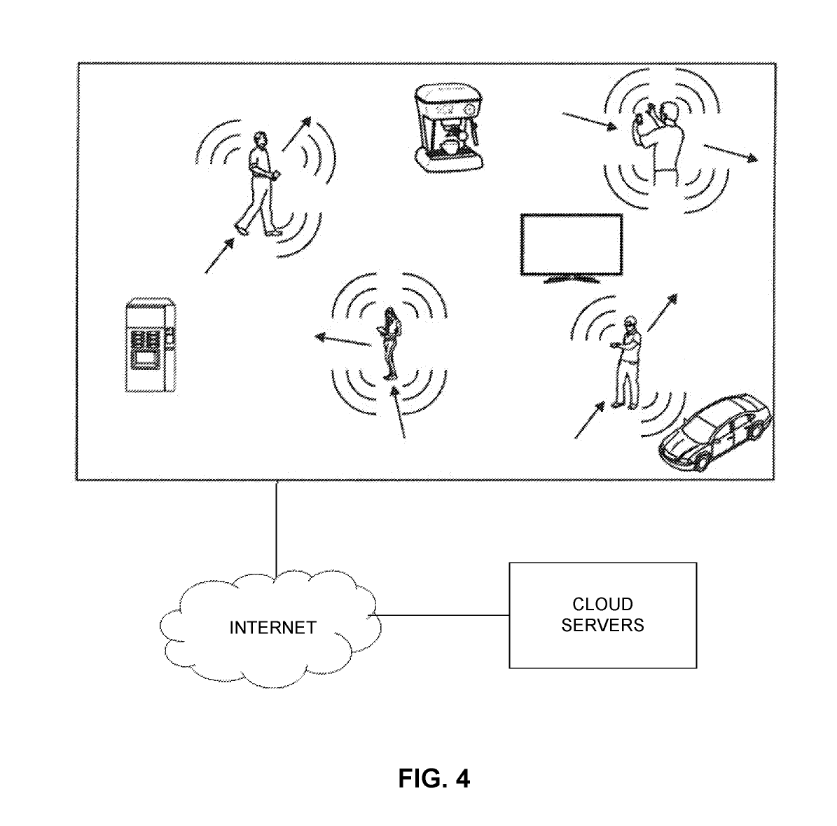

FIG. 4 illustrates a non-limiting example of a physical environment showing different types of electronic devices with signals. As a non-limiting example, the electronic device accesses back-end or the cloud with a server. As a non-limiting example, the server has numerous roles, such as authenticating the entity and maintaining access-control lists for signals and electronic devices.

### Example 3

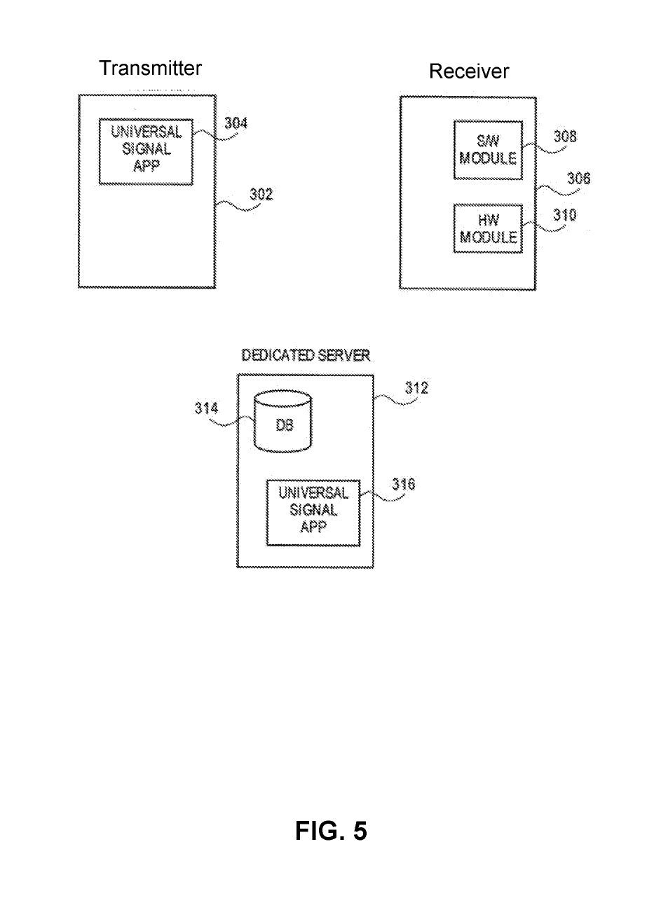

FIG. 5 is a block diagram showing three components used for the Universal ID.

An electronic device 306 acts as the detector or scanner in the environment. As described, device 306 can take the form of one of a multitude of objects as previously disclosed. Nearly all have a software module 308. Software module 308, as well as module 304, performs many of the operations described in the flow diagrams below. In some embodiments, device 306 may also have a hardware component 310, such as a Bluetooth component or other hardware needed for connectivity with signal 302 or with a dedicated server, the other component in FIG. 5.

A server 312 may have extensive software modules, such as the universal signal app 316, and at least one database 314 which stores data on electronic device, entities, access control tables, and a wide variety of data needed to implement the universal signal environment of the present invention.

### Example 4

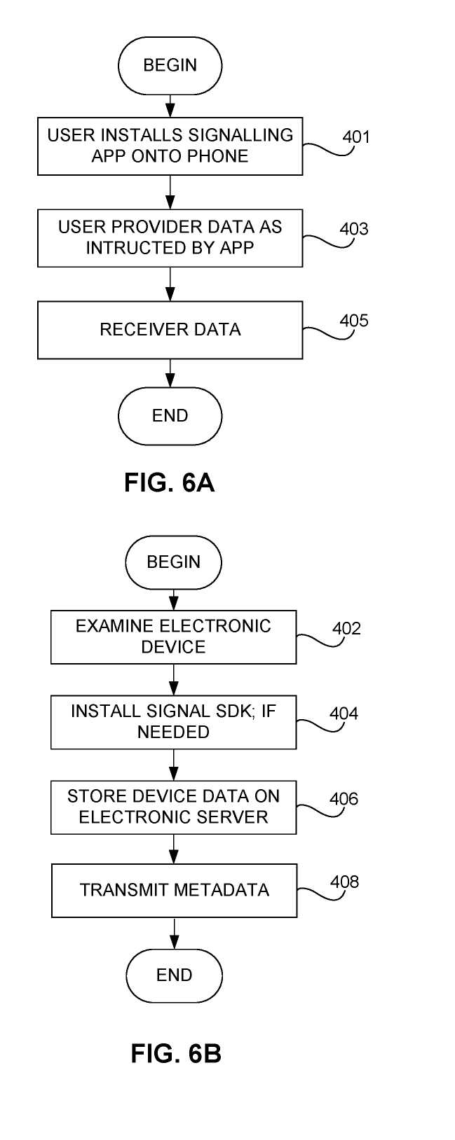

FIG. 6A is a flow diagram of a process of an entity joining the Universal ID signal framework in accordance with one embodiment. The first step taken by the entity is shown at step 401 where the entity downloads a Universal ID signal app (“app”) onto a device including but not limited to a mobile device.

Generally, the app can operate in most widely used personal devices, platforms or operating systems, such as Android, iOS, and others that run on phones, watches, bracelets, tablets, biochips and the like.

Once downloaded and installed, at step 403 the entity enters at least some required basic information about itself. Some of the information can be entered at a later time depending on the apparatus that the app is being installed on. In one embodiment, a subset of the data entered by the entity results in the creation of various identifiers. One may be referred to generically as a unique ID whose use is limited in that it is used primarily, if not only, by back-end or the cloud. This unique ID is not sent to the electronic device. Another is a randomly generated identifier, referred to herein as a temporary or non-permanent ID. In one embodiment, this non-permanent ID is broadcasted from the app on the entities mobile device. This non-permanent ID, for example, may be used for anonymous detection by an electronic device of the entity. Another identifier is created from the entity data is referred to as a permanent ID.

FIG. 6B is a flow diagram of a process of registering and initializing a device so that it can be a Universal ID signal sensing device in a physical space in accordance with one embodiment. At step 402 the back-end or cloud determines whether the electronic device has the necessary hardware for implementing the present invention (since the electronic device is new to the space and the Universal ID framework, the back-end or cloud knows that the electronic device does not have the Universal ID app yet). The back-end or cloud obtains a wide variety of data and metadata about the electronic device, items such as device name, category, location, identifier(s), make, model, time zone and so on.

Some of this data is used to let the entity know what the electronic device is exactly when it encounters it in a physical real-world space and wants to decide whether to interact with it. However, the threshold question determined at step 402 is whether the electronic device has the right hardware. If it does, the service provider only needs to supply and install Universal ID signal software which, in the described embodiment, is in the form of a software development kit (SDK) as shown in step 404. If the electronic device does not have the right hardware for scanning (some smaller scale manufacturers may not have the means or technical skills to include this hardware in their product) the service provider provides one. In this case the software module and the sensor hardware are installed on the electronic device which may be done by the electronic device maker or the service provider.

At step 406 information describing the electronic device is stored by the service provider in a database. This data is required for enabling interaction between the electronic device and the signal. In some scenarios, the data needed for this interaction may be stored on the electronic device itself wherein the service provider does not play an active role. Some examples of data stored include electronic device ID, single key, private/public key pair, set of commands and interactions, actions the entity or electronic device can take, a template which can be customized for different electronic devices. In one embodiment, a template may be described as a pre-defined schema of attributes and metadata. In a simple example, a template for a door lock can have “lock” and “unlock” whereas a template for a car would likely have many more options. At step 408 metadata describing to the electronic device and templates are transmitted to the electronic device and stored there.

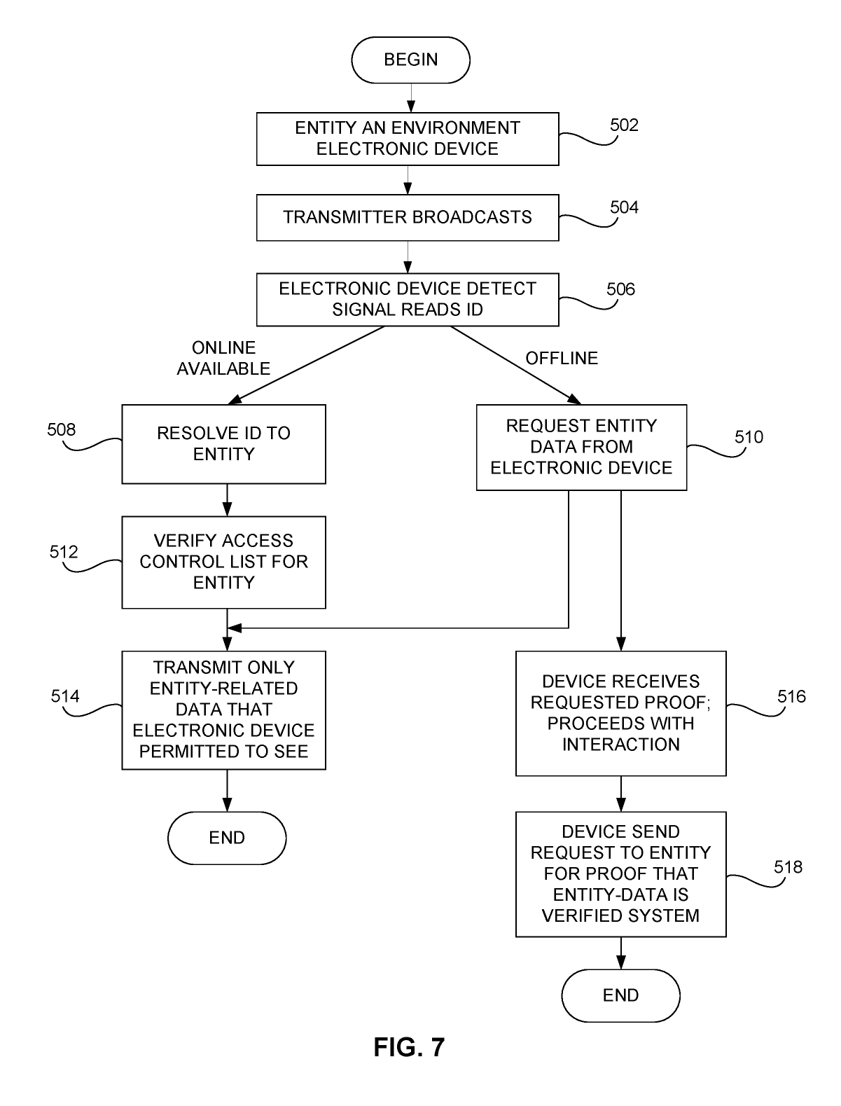

At the end of FIG. 6B, the electronic device is now capable of detecting or sensing a signal when a signal with the Universal ID signal app executing on it is in the presence of the electronic device. FIG. 7 is a flow diagram of a process of passive detection of a universal signal presence in accordance with one embodiment. At step 502 an entity (as noted, the enters an environment or physical space that has scanning electronic devices. It is important to note here that the entity is in control of its personal Universal ID signal. The entity can turn the signal on (by executing the app downloaded at step 401) or not turn it on.

There are also measures that can be taken to ensure that the Universal signal is coming from the right entity and not an imposter or some other intentional or unintentional unauthorized person. At step 502 the entity turns on the signal via an electronic device apparatus once another factor has passed. Only at this point is the signal turned on. This prevents other entities from impersonating the entity by wearing the entities wearable electronic device. At step 504 a signal in the environment broadcasts the non-permanent ID. At step 506 an electronic device detects or senses the signal and reads the signal's non-permanent ID. A non-persistent minimal connection is established initially between the signal and the electronic device.

The Universal ID signal app does not tie up the electronic device exclusively (unlike other IoT electronic devices). Because of the non-persistent nature of the connection some typical scaling issues are avoided. No permanent bonding or tie-up is needed in the personal Universal ID signal implementation and framework of the present invention.

### Example 5

Steps 502 to 506 describe what can be referred to as a sub-process for ambient sensing of the signal by an electronic device. It may be characterized as the simplest use case scenario for the Universal ID signal. Ambient sensing can be used in scenarios where an entity simply has to be distinguished from one another, such as counting how many entities are near an electronic device or in a room. This ambient sensing may also be seen as a way for an entity to potentially communicate with an electronic device if needed. If communication is possible and the dedicated server, such as a service provider server, can be accessed, the process continues with step 508. In another embodiment, the dedicated server can be accessed via another communication means, such as Bluetooth, Ethernet, and the like

At step 508, the service provider server learns private data about the entity. It does this by taking the non-permanent ID and resolving it to an actual or real entity (as noted, prior to this step, the entity was merely an anonymous but distinguishable entity). At step 512 the back-end verifies permissions attached to the entity by examining an access control list. At step 514 the back-end sends entity data based on the access control list to the electronic device, in other words, it sends to the electronic device only data about the entity that the electronic device is allowed to see. The back-end stores a matrix of permissions, policies, preferences, and the like regarding entities and electronic devices. In one embodiment, it uses the entities persistent ID which, as noted, is particular to that entity and a specific electronic device pairing

Returning to step 506, if there is no non-permanent ID or the data needed is already on the electronic device, characterized as a “local only” option, the data needed for sensing the signal is on the electronic device itself and entity data is requested from the electronic device instead of from a service provider server.

The passive branch shown in FIG. 3 has been described in FIG. 7 steps 502 to 514. Steps 510, 516, and 518 illustrate the secure branch from FIG. 3. As noted, at step 510, in the “local only” step, when the electronic device does not access service provider servers via the Internet, entity data is requested from the electronic device. Steps 516 and 518 are needed because the service provider is not able to authenticate entity data or any type of data from the mobile device. The perspective of the queries and actions taken in steps 516 and 518 are from the electronic device perspective. At step 516 the electronic device or, more specifically, the Universal ID signal software module on the electronic device, needs to be able to verify that data it is receiving from the signal at some point has been verified by the service provider and is still valid. The electronic device wants to see that the data (the data basically conveying, for instance, “I am John Smith's mobile device”) has been vouched for by the back-end server, but that the authentication and identity data the electronic device receives has been verified. In one embodiment, this is done without using any of the IDs described above (non-permanent, persistent, unique, etc.). Instead data used to verify the identity depends on the scanning electronic device. Once the electronic device receives this proof or is otherwise confident that the data it is receiving is authentic, control goes to step 518. Here the electronic device receives proof from the mobile device that the entity identity data is authentic and that the electronic device can perform the action, such as unlocking a door, turning a TV on to the entities preferred channel, or make coffee how the entity likes it.

### Example 6

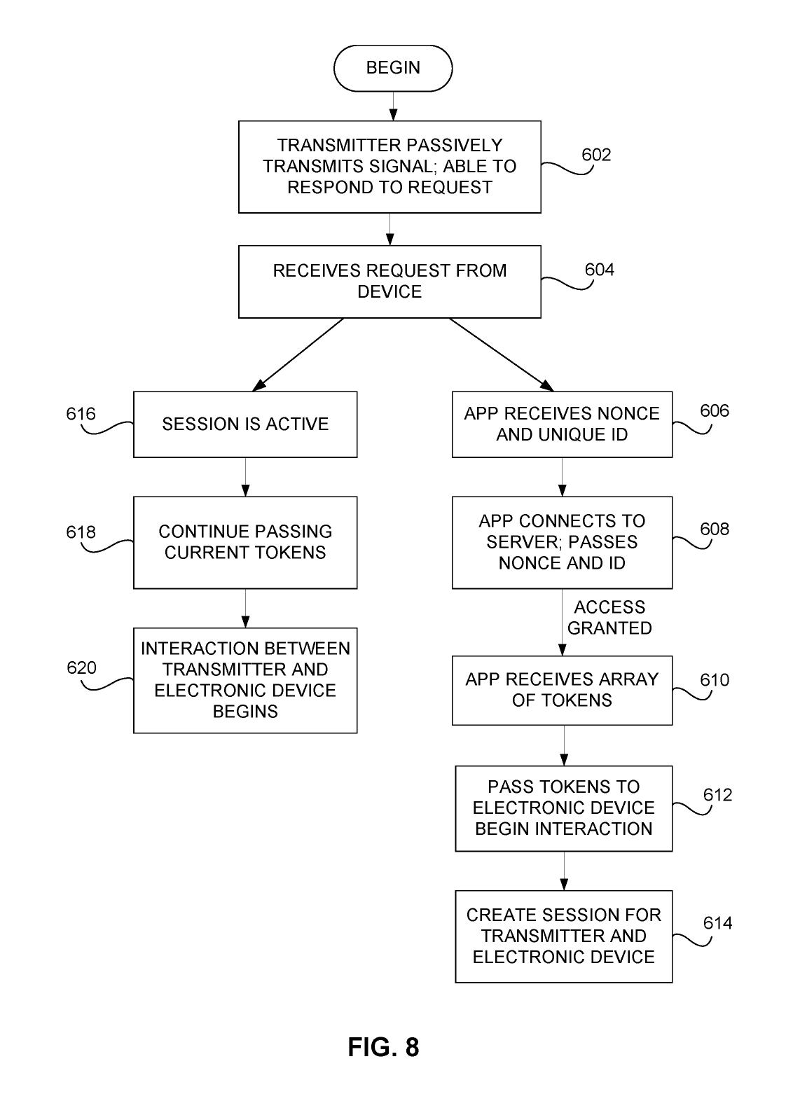

FIG. 8 is a flow diagram of a process of transmitting a Universal ID signal between a signal and an electronic device and initiating interaction between them in accordance with one embodiment. At step 602 the electronic device being carried by an entity has entered a physical space with universal signal-enabled electronic devices and is passively transmitting a Universal ID signal. In one embodiment, this is done by the app in the background essentially when the signal apparatus is powered on. In other embodiments, the app can be terminated or, in contrast, be in the foreground, and be transmitting a universal, personal ID signal. It is also able to detect a request from an electronic device and respond. Although the signal has the Universal ID signal app from the service provider, it does not need anything from the electronic device manufacturer in order to receive the request from the electronic device or respond to it. As noted above, the invention bypasses any form of a “silo” arrangement or framework. The sensors in the electronic devices that are scanning can connect to the signals.

At step 604 the signal receives a request from the electronic device. The app is able to either recognize the request or not. If it does not recognize the request from the electronic device or has not seen a request from the electronic device for a long time (a time exceeding a predetermined threshold), control goes to step 606. The app requests a non-repeatable value or nonce from the electronic device and a fixed unique ID for that electronic device. In other embodiments, this ID can come from the service provider server or through other means, such as through an ID tag via near-field communication or a signal associated with the electronic device. At step 606 the app receives these values.

At step 608 the app connects to the service provider server and transmits these two values to the server. Assuming the server is able to identify the unique ID as belonging to the electronic device, it grants access between the electronic device and the signal. The server uses the nonce for deriving a token as described below. More specifically, it enables access control and security by transmitting an array of tokens to the electronic device. If the server cannot recognize the electronic device from the ID or determines that there is no interest from the entity in accessing or interacting with the electronic device, then tokens are not passed to the smartphone. In some cases, metadata may be passed to the smartphone which provides publicly available, insecure information related to the electronic device such that the entity can act on the information.

For example, the electronic device may be a public electronic device, such as a kiosk or parking meter, and although most of the time the entity is likely to ignore the electronic device, if the entity wants to learn more about the electronic device (e.g., remaining parking time or rate), the entity would be able to do so with the data returned by the dedicated server. In one embodiment, a token has one component that is derived from combining the nonce, the unique electronic device ID, electronic device-specific data, time-limited data, entity restrictions, and so on. It is an important feature of the present invention that communications between the electronic device and entity be secure. All the values and factors that go into making the token play a critical role in making the entire Universal ID signal framework secure.

The second component of a single token is referred to as a payload section and contains data on entity preferences and generally to the entity and electronic device. In one embodiment, each token in the array is valid for a limited time period, such as for a few minutes, hours, or days. An array may have a few hundred tokens and can be used to prove validity from a few hours to several days. For example, for commercial building access, a token may last for 4-5 hours and be replenished often to ensure that there are tokens to last the entity through the day.

In another embodiment, where access to a service provider server may not be available, tokens can be generated on an electronic device, such as a lock, using other factors, such as biometrics fingerprint, voice recognition, face recognition or retina scanner part of the electronic device, geolocation, expiration time, and so on. These features can also be used even if there is access to the service provider server to provide stronger security. As is known in the art, a token is a signed data item, intended to be used once and discarded (as does an entire array of tokens). Getting back to the importance of security in a Universal ID signal framework, the array of tokens that is sent from the service provider server to the electronic device, together with other security features, prevents possible hacking and malfeasance, for instance, “replaying” or emulation (harmful electronic devices emulating valid, authorized electronic devices), among others.

At step 612 the app passes one of the tokens from the array or the entire array of tokens to the electronic device. The electronic device validates the tokens and interactions between the entity and the electronic device can begin. More specifically, the Universal ID signal software module on the electronic device validates the tokens and sends a message to the smart phone stating that they can now communicate. Upon receiving this message, at step 614 the signal creates a session and the two can now interact.

Returning to step 604, if the signal app recognizes the request from the electronic device, control continues with step 616 where a session between the smartphone and the electronic device is already active. This session is of the same type as the one created at step 614. The array of tokens may be stored in a cache or local storage on the smartphone. By doing so, the smartphone does not have to be online; it can be offline and operate fast. At step 618 the smartphone continues passing tokens to the electronic device. The smartphone keeps the tokens for a predetermined amount of time, a threshold of time that balances security and entity convenience, for example, a few hours. After that time has expired, the app gets a new array of tokens from the service provider. If they have not expired, the smartphone can keep using the tokens in the array. At step 620 the interaction between the entity and the electronic device can resume. In this manner, that is by executing the operations in steps 604 to 614 or steps 604, 616, 618, and 620, a secure, truly Universal ID signal that is usable by many different types of electronic devices.

### Example 7

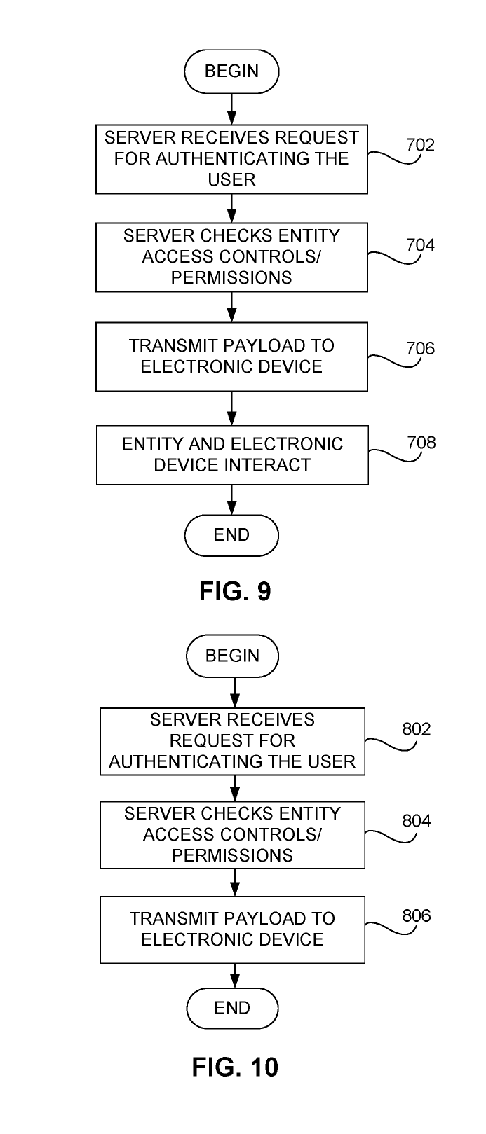

FIG. 9 is a flow diagram of a process of operations that occur on the electronic device when the electronic device is online in accordance with one embodiment. At step 702 the service provider server receives a request from an electronic device, for example a car or an appliance, for authenticating an entity. It is helpful to note that an electronic device can only see entities who have allowed that specific electronic device to recognize or see them (a category of electronic devices or a specific manufacturer or member group may also be specified. Similarly, in some physical environments, such as a workplace or other secured area, an entity is only allowed to see electronic devices that an overseeing entity (e.g., employer) says she is allowed to see or recognize. In other contexts, an electronic device maker may only want entities with certain features or characteristics to be able to see or recognize its electronic devices.

Various types of scenarios are possible in which either the entity or the electronic device maker or owner, manager, and the like can set security protocols regarding who or what can be recognized using the Universal ID signal. For example, one benefit of this type of security is that it prevents the equivalent of spamming on both sides. In all scenarios, the underlying security principle that is implemented in the various embodiments of the invention is that either side—entity or electronic device—only gets to see and receive what it needs to in order to interact, and can only get to that point if the entity or electronic device is authorized to see the other. At step 704 the service provider server checks entity access controls to see if the entity is authorized to use the electronic device and if so what controls or limits are there. There are different techniques or transport mechanisms for how this entity access control check can be performed by the service provider.

For example, in one embodiment, there may be an out-of-band token exchange or a token server. The common factor is translating the random, non-identifying ID for the entity that was transmitted initially to the electronic device into a full set of information about the entity. This information can be used in a permission check process. At step 706, assuming the entity is authenticated, the service provider server transmits the payload to the electronic device so now the electronic device knows the entity's preferences, permissions, interaction history, and other information. At step 708 the entity and electronic device can begin substantive interaction.

### Example 8

FIG. 10 is a flow diagram of a process that occurs on the electronic device when the electronic device is offline in accordance with one embodiment. The end goal of this process is essentially the same as that of FIG. 9, except here the electronic device does not communicate with the service provider server. At step 802 the electronic device makes a request for an array of tokens from the entity. The nature and characteristics of this array of tokens are the same as the token array described above. At step 804 the electronic device receives a token from the signal. At step 806 the electronic device proceeds with verifying the token using only local resources.

In various embodiments, it can verify or check the signature in the tokens, it can check to ensure it has not expired or has not been used before. Through these means and others, if available locally, the electronic device authenticates the entity and interaction between the entity (who may or may not be online) and the offline electronic device can begin. As noted above, with regard to security, one important aspect of that is embedded in the validation period of a token. This period can vary from a few minutes to several weeks. A token for a coffee machine may last 20 days whereas for a lock or for making payments, a token may expire after one hour. This security feature is typically set by the electronic device manufacturer; they decide how long to wait before an entity has to re-authenticate with the electronic device. Generally, entities will have little input in this regard. Another scenario not described in FIGS. 9 and 10 is when the electronic device and smartphone are both unable to reach a service provider or dedicated server and have not connected or interacted with each other before. In this scenario, even though the mobile device has the Universal ID signal app and the electronic device registered with the service provider, there is no recognition of each other, let alone any interaction.

FIG. 11 is an illustration of a data processing system 900 is depicted in accordance with some embodiments. Data processing system 900 may be used to implement one or more computers used in a controller or other components of various systems described above. In some embodiments, data processing system 900 includes communications framework 902, which provides communications between processor unit 904, memory 906, persistent storage 908, communications unit 910, input/output (I/O) unit 912, and display 914. In this example, communications framework 902 may take the form of a bus system.

Processor unit 904 serves to execute instructions for software that may be loaded into memory 906. Processor unit 904 may be a number of processors, a multi-processor core, or some other type of processor, depending on the particular implementation.

Memory 906 and persistent storage 908 are examples of storage electronic devices 916. A storage electronic device is any piece of hardware that is capable of storing information, such as, for example, without limitation, data, and program code in functional form, and/or other suitable information either on a non-permanent and/or a permanent basis. Storage electronic devices 916 may also be referred to as computer readable storage electronic devices in these illustrative examples. Memory 906, in these examples, may be, for example, a random-access memory or any other suitable volatile or non-volatile storage electronic device. Persistent storage 908 may take various forms, depending on the particular implementation. For example, persistent storage 908 may contain one or more components or electronic devices.

For example, persistent storage 908 may be a hard drive, a flash memory, a rewritable optical disk, a rewritable magnetic tape, or some combination of the above. The media used by persistent storage 908 also may be removable. For example, a removable hard drive may be used for persistent storage 908.

Communications unit 910, in these illustrative examples, provides for communications with other data processing systems or electronic devices. In these illustrative examples, communications unit 910 is a network interface card.

Input/output unit 912 allows for input and output of data with other electronic devices that may be connected to data processing system 900. For example, input/output unit 912 may provide a connection for entity input through a keyboard, a mouse, and/or some other suitable input electronic device. Further, input/output unit 912 may send output to a printer. Display 914 provides a mechanism to display information to an entity.

Instructions for the operating system, applications, and/or programs may be located in storage electronic devices 916, which are in communication with processor unit 904 through communications framework 902. The processes of the different embodiments may be performed by processor unit 904 using computer-implemented instructions, which may be located in a memory, such as memory 906.

These instructions are referred to as program code, computer usable program code, or computer readable program code that may be read and executed by a processor in processor unit 904. The program code in the different embodiments may be embodied on different physical or computer readable storage media, such as memory 906 or persistent storage 908.

Program code 918 is located in a functional form on computer readable media 920 that is selectively removable and may be loaded onto or transmitted to data processing system 900 for execution by processor unit 904. Program code 918 and computer readable media 920 form computer program product 922 in these illustrative examples. In one example, computer readable media 920 may be computer readable storage media 924 or computer readable signal media 926. In these illustrative examples, computer readable storage media 924 is a physical or tangible storage electronic device used to store program code 918 rather than a medium that propagates or transmits program code 918. Alternatively, program code 918 may be transmitted to data processing system 900 using computer readable signal media 926. Computer readable signal media 926 may be, for example, a propagated data signal containing program code 918. For example, computer readable signal media 926 may be an electromagnetic signal, an optical signal, and/or any other suitable type of signal. These signals may be transmitted over communications channels, such as wireless communications channels, optical fiber cable, coaxial cable, a wire, and/or any other suitable type of communications channel.

The different components illustrated for data processing system 900 are not meant to provide architectural limitations to the manner in which different embodiments may be implemented. The different illustrative embodiments may be implemented in a data processing system including components in addition to and/or in place of those illustrated for data processing system 900. Other components shown in FIG. 11 can be varied from the illustrative examples shown. The different embodiments may be implemented using any hardware electronic device or system capable of running program code 918.

Cloud System

As a non-limiting example, one embodiment of a cloud system is illustrated in FIGS. 12A-12E.

The cloud-based system includes a third-party service provider, that is provided by the methods used with the present invention, that can concurrently service requests from several clients without an entity perception of degraded computing performance as compared to conventional techniques where computational tasks can be performed upon a client or a server within a proprietary intranet. The third-party service provider (e.g., “cloud”) supports a collection of hardware and/or software resources. The hardware and/or software resources can be maintained by an off-premises party, and the resources can be accessed and utilized by identified entities over Network Systems. Resources provided by the third-party service provider can be centrally located and/or distributed at various geographic locations. For example, the third-party service provider can include any number of data center machines that provide resources. The data center machines can be utilized for storing/retrieving data, effectuating computational tasks, rendering graphical outputs, routing data, and so forth.

In one embodiment, the third-party service provider can provide any number of resources such as servers, CPU's, data storage services, computational services, word processing services, electronic mail services, presentation services, spreadsheet services, web syndication services (e.g., subscribing to an RSS feed), and any other services or applications that are conventionally associated with personal computers and/or local servers. Further, utilization of any number of third party service providers similar to the third-party service provider is contemplated. According to an illustration, disparate third-party service providers can be maintained by differing off-premise parties and an entity can employ, concurrently, at different times, and the like, all or a subset of the third-party service providers.

By leveraging resources supported by the third-party service provider, limitations commonly encountered with respect to hardware associated with clients and servers within proprietary intranets can be mitigated. Off-premises parties, instead of entities or network administrators of servers within proprietary intranets, can maintain, troubleshoot, replace and update the hardware resources. Further, for example, lengthy downtimes can be mitigated by the third-party service provider utilizing redundant resources; thus, if a subset of the resources are being updated or replaced, the remainder of the resources can be utilized to service requests from entities. According to this example, the resources can be modular in nature, and thus, resources can be added, removed, tested, modified, etc. while the remainder of the resources can support servicing entity requests. Moreover, hardware resources supported by the third-party service provider can encounter fewer constraints with respect to storage, processing power, security, bandwidth, redundancy, graphical display rendering capabilities, etc. as compared to conventional hardware associated with clients and servers within proprietary intranets.

The cloud-based system can include a client electronic device that employs resources of the third-party service provider. Although one client electronic device is depicted, it is to be appreciated that the cloud-based system can include any number of client electronic devices similar to the client electronic device, and the plurality of client electronic devices can concurrently utilize supported resources. By way of illustration, the client electronic device can be a desktop electronic device (e.g., personal computer), motion/movement/gesture detection electronic device, and the like. Further, the client electronic device can be an embedded system that can be physically limited, and hence, it can be beneficial to leverage resources of the third-party service provider.

Resources can be shared amongst a plurality of client electronic devices subscribing to the third-party service provider. According to an illustration, one of the resources can be at least one central processing unit (CPU), where CPU cycles can be employed to effectuate computational tasks requested by the client electronic device. Pursuant to this illustration, the client electronic device can be allocated a subset of an overall total number of CPU cycles, while the remainder of the CPU cycles can be allocated to disparate client electronic device(s). Additionally, or alternatively, the subset of the overall total number of CPU cycles allocated to the client electronic device can vary over time. Further, a number of CPU cycles can be purchased by the entity of the client electronic device. In accordance with another example, the resources can include data store(s) that can be employed by the client electronic device to retain data. The entity employing the client electronic device can have access to a portion of the data store(s) supported by the third-party service provider, while access can be denied to remaining portions of the data store(s) (e.g., the data store(s) can selectively mask memory based upon entity/electronic device identity, permissions, and the like). It is contemplated that any additional types of resources can likewise be shared.

The third-party service provider can further include an interface component that can receive input(s) from the client electronic device and/or enable transferring a response to such input(s) to the client electronic device (as well as perform similar communications with any disparate client electronic devices). According to an example, the input(s) can be request(s), data, executable program(s), etc. For instance, request(s) from the client electronic device can relate to effectuating a computational task, storing/retrieving data, rendering an entity interface, and the like via employing one or more resources. Further, the interface component can obtain and/or transmit data over a network connection. According to an illustration, executable code can be received and/or sent by the interface component over the network connection. Pursuant to another example, an entity (e.g. employing the client electronic device) can issue commands via the interface component.

Moreover, the third-party service provider includes a dynamic allocation component that apportions resources (e.g., hardware resource(s)) supported by the third-party service provider to process and respond to the input(s) (e.g., request(s), data, executable program(s) and the like) obtained from the client electronic device.

Although the interface component is depicted as being separate from the dynamic allocation component, it is contemplated that the dynamic allocation component can include the interface component or a portion thereof. The interface component can provide various adaptors, connectors, channels, communication paths, etc. to enable interaction with the dynamic allocation component.

As a non-limiting example, the first entity can use the cloud-based system to determine a state associated with a Universal ID entity, where the state can relate to a set of properties. For instance, the first entity can analyze explicit and/or implicit information obtained from the first entity electronic device, system, app and the like (e.g., via the interface component) and/or retrieved from memory associated with the cloud services provider (e.g., preferences indicated in subscription data). State related data yielded by the first entity can be utilized by the dynamic allocation component to tailor the apportionment of resources.

In one embodiment, the first entity can consider characteristics of the first entity electronic device, system, app and the like, which can be used to apportion resources by the dynamic allocation component. For instance, the first entity can identify that the first entity electronic device, system, app and the like is a mobile electronic device with limited display area.

In one embodiment a system archives and/or analyzes data relative to the Universal ID utilizing the cloud services provider. The cloud services provider can include the interface component that enables communicating with the first entity electronic device, system, app and the like. Further, the cloud services provider comprises the dynamic allocation component that can apportion data retention resources, for example. Moreover, the cloud services provider can include an archive component and any number of data store(s). Access to and/or utilization of the archive component and/or the data store(s) by the first entity electronic device, system, app and the like (and/or any disparate first entity electronic device, system, app and the like(s)) can be controlled by the dynamic allocation component. The data store(s) can be centrally located and/or positioned at different geographic locations. Further, the archive component can include a management component, a versioning component, a security component, a permission component, an aggregation component, and/or a restoration component.

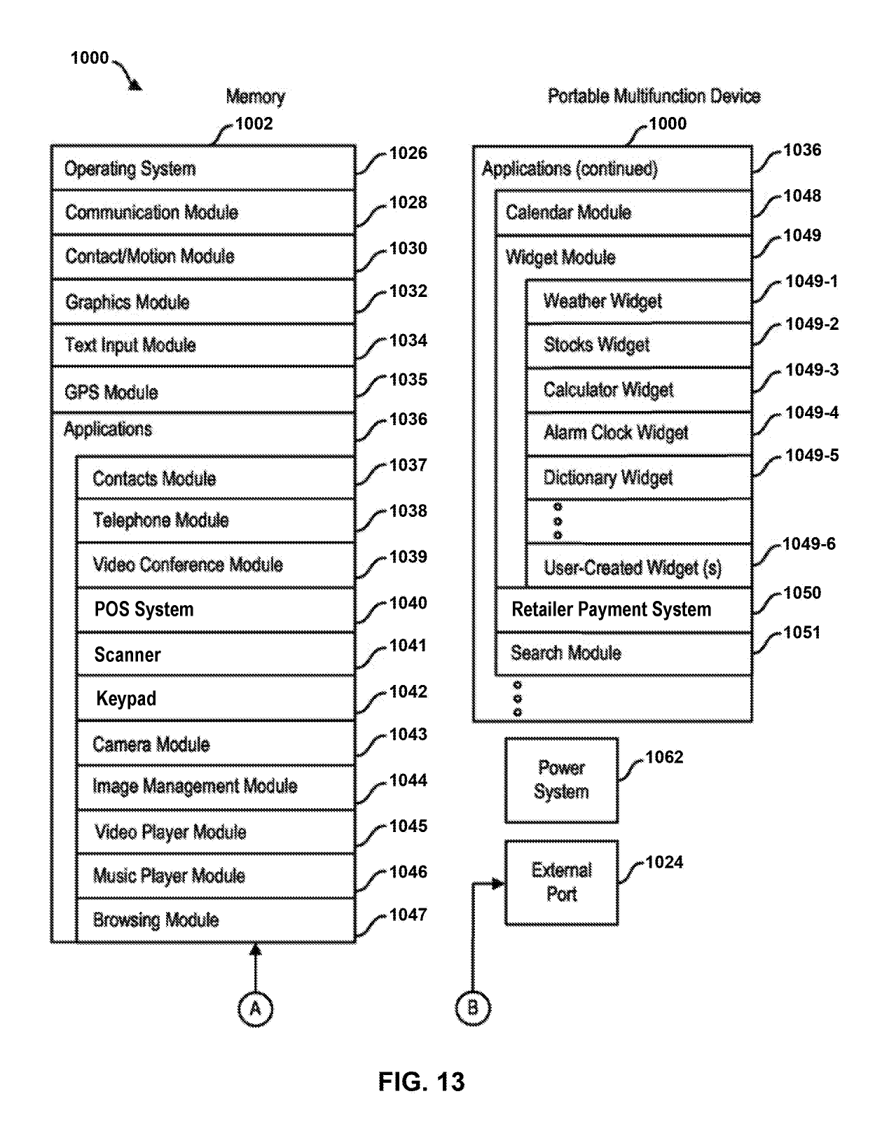

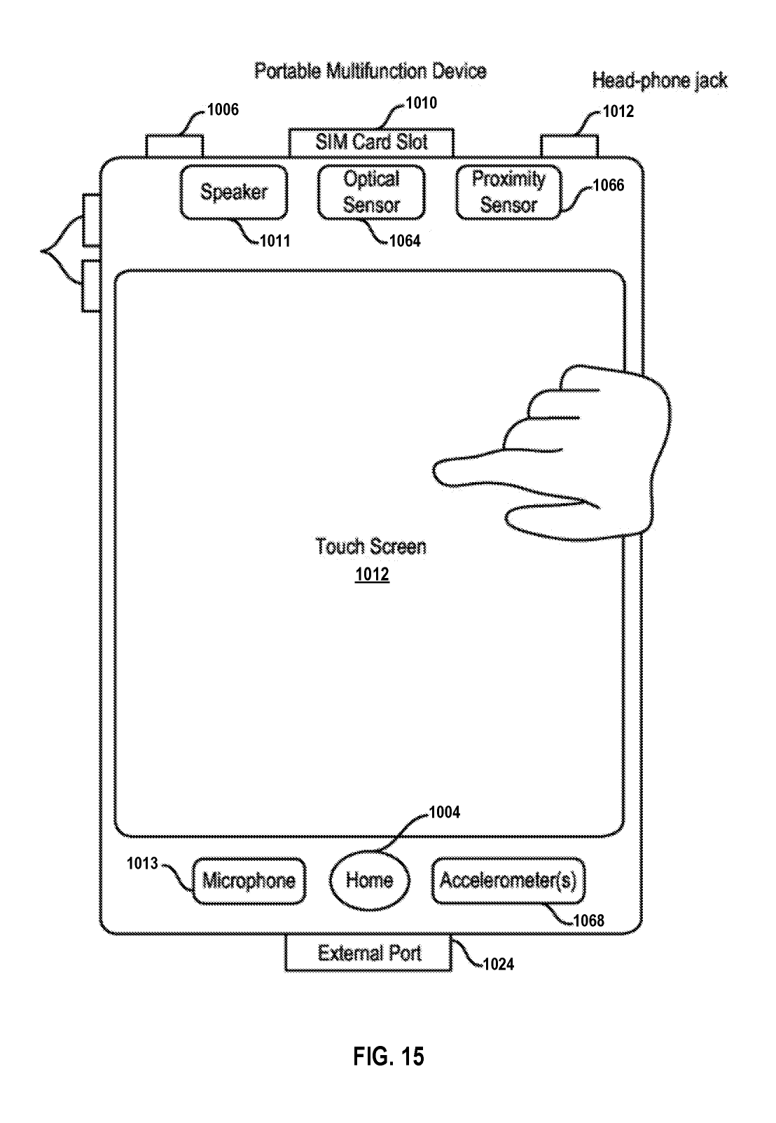

FIGS. 13-15 illustrate one embodiment of an electronic device. As illustrated the electronic device is a mobile device that is used with system 10. As non-limiting examples, other types of electronic devices can include at least a portion of the FIGS. 13-15 elements.

The mobile or computing device 1000 can include a display that can be a touch sensitive display 1012. The touch-sensitive display 1012 is sometimes called a “touch screen” for convenience, and may also be known as or called a touch-sensitive display system 1012. The mobile or computing device 1000 may include a memory 1002 (which may include one or more computer readable storage mediums), a memory controller 1022, one or more processing units (CPU's) 1020, a peripherals interface 1018, Network Systems circuitry 1080, including but not limited to RF circuitry, audio circuitry 1010, a speaker 1011, a microphone 1013, an input/output (I/O) subsystem 1006, other input or control devices 1060, and an external port 1024. The mobile or computing device 1000 may include one or more optical sensors 1064. These components may communicate over one or more communication buses or signal lines 1003.

It should be appreciated that the mobile or computing device 1000 is only one example of a portable multifunction mobile or computing device 1000, and that the mobile or computing device 1000 may have more or fewer components than shown, may combine two or more components, or a may have a different configuration or arrangement of the components. The various components may be implemented in hardware, software or a combination of hardware and software, including one or more signal processing and/or application specific integrated circuits.

Memory 1002 may include high-speed random-access memory and may also include non-volatile memory, such as one or more magnetic disk storage devices, flash memory devices, or other non-volatile solid-state memory devices. Access to memory 1002 by other components of the mobile or computing device 1000, such as the CPU 1020 and the peripherals interface 1018, may be controlled by the memory controller 1022.

The peripherals interface 1018 couples the input and output peripherals of the device to the CPU 1020 and memory 1002. The one or more processors 1020 run or execute various software programs and/or sets of instructions stored in memory 1002 to perform various functions for the mobile or computing device 1000 and to process data.

In some embodiments, the peripherals interface 1018, the CPU 1020, and the memory controller 1022 may be implemented on a single chip, such as a chip 1004. In some other embodiments, they may be implemented on separate chips.

The Network System circuitry 1080 receives and sends signals, including but not limited to RF, also called electromagnetic signals. The Network System circuitry 1080 converts electrical signals to/from electromagnetic signals and communicates with communications networks and other communications devices via the electromagnetic signals. The Network Systems circuitry 1080 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The Network Systems circuitry 1080 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication.

The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (WCDMA), code division multiple access (CDMA), time division multiple access (TDMA), BLUETOOTH®, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

The audio circuitry 1010, the speaker 1011, and the microphone 1013 provide an audio interface between an entity and the mobile or computing device 1000. The audio circuitry 1010 receives audio data from the peripherals interface 1018, converts the audio data to an electrical signal, and transmits the electrical signal to the speaker 1011. The speaker 1011 converts the electrical signal to human-audible sound waves. The audio circuitry 1010 also receives electrical signals converted by the microphone 1013 from sound waves. The audio circuitry 1010 converts the electrical signal to audio data and transmits the audio data to the peripherals interface 1018 for processing. Audio data may be retrieved from and/or transmitted to memory 1002 and/or the Network Systems circuitry 1080 by the peripherals interface 1018. In some embodiments, the audio circuitry 1010 also includes a headset jack. The headset jack provides an interface between the audio circuitry 1010 and removable audio input/output peripherals, such as output-only headphones or a headset with both output (e.g., a headphone for one or both ears) and input (e.g., a microphone).

The I/O subsystem 1006 couples input/output peripherals on the mobile or computing device 1000, such as the touch screen 1012 and other input/control devices 1016, to the peripherals interface 1018. The I/O subsystem 1006 may include a display controller 1056 and one or more input controllers 1060 for other input or control devices. The one or more input controllers 1060 receive/send electrical signals from/to other input or control devices 1016. The other input/control devices 1016 may include physical buttons (e.g., push buttons, rocker buttons, etc.), dials, slider switches, and joysticks, click wheels, and so forth. In some alternate embodiments, input controller(s) 1060 may be coupled to any (or none) of the following: a keyboard, infrared port, USB port, and a pointer device such as a mouse. The one or more buttons may include an up/down button for volume control of the speaker 1011 and/or the microphone 1013. The one or more buttons may include a push button. The touch screen 1012 is used to implement virtual or soft buttons and one or more soft keyboards.

The touch-sensitive touch screen 1012 provides an input interface and an output interface between the device and an entity. The display controller 1056 receives and/or sends electrical signals from/to the touch screen 1012. The touch screen 1012 displays visual output to the entity. The visual output may include graphics, text, icons, video, and any combination thereof (collectively termed “graphics”). In some embodiments, some or all of the visual output may correspond to entity-interface objects, further details of which are described below.

A touch screen 1012 has a touch-sensitive surface, sensor or set of sensors that accepts input from the entity based on haptic and/or tactile contact. The touch screen 1012 and the display controller 1056 (along with any associated modules and/or sets of instructions in memory 1002) detect contact (and any movement or breaking of the contact) on the touch screen 1012 and converts the detected contact into interaction with entity-interface objects (e.g., one or more soft keys, icons, web pages or images) that are displayed on the touch screen. In an exemplary embodiment, a point of contact between a touch screen 1012 and the entity corresponds to a finger of the entity.

The touch screen 1012 may use LCD (liquid crystal display) technology, or LPD (light emitting polymer display) technology, although other display technologies may be used in other embodiments. The touch screen 1012 and the display controller 1056 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 1012.

A touch-sensitive display in some embodiments of the touch screen 1012 may be analogous to the multi-touch sensitive tablets described in the following U.S. Pat. No. 6,323,846 (Westermann et al.), U.S. Pat. No. 6,570,557 (Westermann et al.), and/or U.S. Pat. No. 6,677,932 (Westermann), and/or U.S. Patent Publication 2002/0015024A1, each of which is hereby incorporated by reference in their entirety. However, a touch screen 1012 displays visual output from the portable mobile or computing device 1000, whereas touch sensitive tablets do not provide visual output.

A touch-sensitive display in some embodiments of the touch screen 1012 may be as described in the following applications: (1) U.S. patent application Ser. No. 11/381,313, “Multipoint Touch Surface Controller,” filed May 10, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

The touch screen 1012 may have a resolution in excess of 1000 dpi. In an exemplary embodiment, the touch screen has a resolution of approximately 1060 dpi. The entity may contact the touch screen 1012 using any suitable object or appendage, such as a stylus, a finger, and so forth. In some embodiments, the entity interface is designed to work primarily with finger-based contacts and gestures, which are much less precise than stylus-based input due to the larger area of contact of a finger on the touch screen. In some embodiments, the device translates the rough finger-based input into a precise pointer/cursor position or command for performing the actions desired by the entity.

In some embodiments, in addition to the touch screen, the mobile or computing device 1000 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from the touch screen 1012 or an extension of the touch-sensitive surface formed by the touch screen.

In some embodiments, the mobile or computing device 1000 may include a physical or virtual click wheel as an input control device 1016. An entity may navigate among and interact with one or more graphical objects (henceforth referred to as icons) displayed in the touch screen 1012 by rotating the click wheel or by moving a point of contact with the click wheel (e.g., where the amount of movement of the point of contact is measured by its angular displacement with respect to a center point of the click wheel). The click wheel may also be used to select one or more of the displayed icons. For example, the entity may press down on at least a portion of the click wheel or an associated button. Entity commands and navigation commands provided by the entity via the click wheel may be processed by an input controller 1060 as well as one or more of the modules and/or sets of instructions in memory 1002. For a virtual click wheel, the click wheel and click wheel controller may be part of the touch screen 1012 and the display controller 1056, respectively. For a virtual click wheel, the click wheel may be either an opaque or semi-transparent object that appears and disappears on the touch screen display in response to entity interaction with the device. In some embodiments, a virtual click wheel is displayed on the touch screen of a portable multifunction device and operated by entity contact with the touch screen.

The mobile or computing device 1000 also includes a power system 1062 for powering the various components. The power system 1062 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The mobile or computing device 1000 may also include one or more sensors 1064, including not limited to optical sensors 1064. An optical sensor can be coupled to an optical sensor controller 1058 in I/O subsystem 1006. The optical sensor 1064 may include charge-coupled device (CCD) or complementary metal-oxide semiconductor (CMOS) phototransistors. The optical sensor 1064 receives light from the environment, projected through one or more lens, and converts the light to data representing an image. In conjunction with an imaging module 1043 (also called a camera module); the optical sensor 1064 may capture still images or video. In some embodiments, an optical sensor is located on the back of the mobile or computing device 1000, opposite the touch screen display 1012 on the front of the device, so that the touch screen display may be used as a viewfinder for either still and/or video image acquisition. In some embodiments, an optical sensor is located on the front of the device so that the entities image may be obtained for videoconferencing while the entity views the other video conference participants on the touch screen display. In some embodiments, the position of the optical sensor 1064 can be changed by the entity (e.g., by rotating the lens and the sensor in the device housing) so that a single optical sensor 1064 may be used along with the touch screen display for both video conferencing and still and/or video image acquisition.

The mobile or computing device 1000 may also include one or more proximity sensors 1066. In one embodiment, the proximity sensor 1066 is coupled to the peripherals interface 1018. Alternately, the proximity sensor 1066 may be coupled to an input controller in the I/O subsystem 1006. The proximity sensor 1066 may perform as described in U.S. patent application Ser. No. 11/241,839, “Proximity Detector In Handheld Device,” filed Sep. 30, 2005; Ser. No. 11/240,788, “Proximity Detector In Handheld Device,” filed Sep. 30, 2005; Ser. No. 13/096,386, “Using Ambient Light Sensor To Augment Proximity Sensor Output”; Ser. No. 11/586,862, “Automated Response To And Sensing Of User Activity In Portable Devices,” filed Oct. 24, 2006; and Ser. No. 11/638,251, “Methods And Systems For Automatic Configuration Of Peripherals,” which are hereby incorporated by reference in their entirety. In some embodiments, the proximity sensor turns off and disables the touch screen 1012 when the multifunction device is placed near an entities ear (e.g., when the entity is making a phone call).

In some embodiments, the software components stored in memory 1002 may include an operating system 1026, a communication module (or set of instructions) 1028, a contact/motion module (or set of instructions) 1030, a graphics module (or set of instructions) 1032, a text input module (or set of instructions) 1034, a Global Positioning System (GPS) module (or set of instructions) 1035, and applications (or set of instructions) 1036.

The operating system 1026 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 1028 facilitates communication with other devices over one or more external ports 1024 and also includes various software components for handling data received by the Network Systems circuitry 1080 and/or the external port 1024. The external port 1024 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Computer, Inc.) devices.

The contact/motion module 1030 may detect contact with the touch screen 1012 (in conjunction with the display controller 1056) and other touch sensitive devices (e.g., a touchpad or physical click wheel). The contact/motion module 1030 includes various software components for performing various operations related to detection of contact, such as determining if contact has occurred, determining if there is movement of the contact and tracking the movement across the touch screen 1012, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). In some embodiments, the contact/motion module 106 and the display controller 1046 also detects contact on a touchpad. In some embodiments, the contact/motion module 1030 and the controller 1022 detects contact on a click wheel.

Examples of other applications that may be stored in memory 1002 include other word processing applications, JAVA enabled applications, encryption, digital rights management, voice recognition, and voice replication.

In conjunction with touch screen 1012, display controller 1056, contact module 1037, graphics module 1032, and text input module 1034, a contacts module 1037 may be used to manage an address book or contact list, including: adding name(s) to the address book; deleting names) from the address book; associating telephone number(s), e-mail address(es), physical address(es) or other information with a name; associating an image with a name; categorizing and sorting names; providing telephone numbers or e-mail addresses to initiate and/or facilitate communications by telephone, video conference, e-mail, or IM; and so forth.

In one embodiment the Universal ID includes or is layered with biometric identifiers that are the distinctive, measurable characteristics used to label and describe an entity. In one embodiment biometric identifiers include identifiers that can be both physiological and behavioral characteristics. As a non-limiting example, physiological characteristic is related to the shape of the body. Non-limiting examples include, but are not limited to: fingerprint, palm veins, face recognition, DNA, palm print, hand geometry, iris recognition, retina, odor/scent, and the like. Behavioral biometric identifiers are related to the pattern of behavior of a person, including but not limited to typing rhythm, gait, voice, gestures and the like. As a non-limiting example, a Universal ID can for any number of that an entity has, and also allows for a second entity, with permissions by the first entity, to use all or a portion of the first entities electronic devices to create an action.

In one embodiment the Universal ID is layered with biometric identifiers senses an entities physical presence and identifies that entity passively in the physical environment. This provides that no face or voice markers or biometric identifiers, including but not limited to face or voice markers are stored on a local or centralized server and reduces or eliminates biometric identifiers being stolen by hackers. As a non-limiting example this can achieved using a camera for facial recognition, a microphone for a voice recognition, and the like.

In one embodiment a local database is not required to store the biometric identifiers for every entity for every application with a second entity. As a non-limiting example, an entities physical presence is sensed and identification of that entity is done passively in the physical environment. As a non-limiting example this is achieved using a camera for facial recognition, and or a microphone for a voice recognition. This provides that no face, voice markers, or other biometric identifiers is stored on a local or centralized server and reduces or eliminates biometric identifiers being stolen by hackers.

In one embodiment this is achieved by storing only the entity's biometric identifiers on an entities personal electronic device, including but not limited to a mobile device, wearable device and the like, as described in FIGS. 13-15, in an encrypted from that is unique to that entity. As a non-limiting example, the entities biometric identifiers can be stored at memory 906, persistent storage 908 and the like. In one embodiment a protocol for all electronic devices, cameras, microphones, and the like, passes in a special hash of the biometric identifiers to an entity's electronic device and stored therein. In one embodiment there is an app for the electronic device that takes the hashed biometric identifier, compares it to the entity's biometric identifiers stored at the electronic device, and returns a token that either verifies who the entity is or returns a did-not-match result to the electronic device or camera. Once the electronic device receives this token, it can either use it via a server to request more information about this entity, or the token itself can include such information.

In this manner biometric identifiers are detected and controlled. This enables the entity to choose what information to share without concern about millions of discrete systems, devices and electronics in the physical world storing their unique biometric identifiers and limiting the potential for a global surveillance system.

### Example 9

As a non-limiting example, an entity is going to board a plane for travel. The entity walks to the plane without doing anything. The entity has a mobile device. A kiosk is approached to provide passenger check in. In one embodiment the kiosk has a camera, a microphone, a detector, and the like. The entity has its mobile device that emits an ID signal. The kiosk has an ID signal sensor. A presence layer connector is created between the two. In one embodiment the camera sees the entities face and creates a hash. The hash is sent through the mobile device in memory 906. The camera and the mobile device do not know anything about each other. The hash is a unique key that identifies the face. A face verify signal is then verified in the memory 906 and says yes if there is a match. When there is a match a token is then send back to the kiosk where it is decrypted with all of the entities needed information. The second token is different from the first token. The Universal ID is only used to match, and the kiosk does not have a database of the entities biometric information.

In one embodiment system 10 is utilized with two or more wireless communication devices, 30, see FIG. 1, the term wireless refers to the communication or transmission of information over a distance without requiring wires, cables or any other electrical conductors. As non-limiting examples, the different types of wireless communication devices include but are not limited to IR wireless communication, satellite communication, broadcast radio, Microwave radio, Bluetooth, WiFi, Zigbee and the like. In one embodiment a first wireless communication device 30 is a BLE radio and a second wireless communication device is a WiFi radio 30.

In one embodiment the two wireless communication devices 30 can be included with system 10, and be passively send information, including all or a portion of the Universal ID. As non-limiting examples the wireless communication devices 30 can: query for information; interpret an entity's intent. As a non-limiting example sending, by one or more of the wireless communication devices 30, is used to detect some action. In one embodiment signal strength of the wireless communication devices 30 is used to determine what actions an entity desires to take. In one embodiment calibration is performed between the first and second wireless communication devices 30 using methods well known in the art. Calibration is performed because there can be different signal strength and characteristics between the wireless communication devices. An entity uses use proximity for an entity to achieve some desired action and/or intent.

In one embodiment system 10 is used with the at least two wireless communication devices 30 that are able to detect advertising signals while in the process of connecting to electronic devices. In another embodiment system 10 is used with at least two wireless communication devices 30 and reduce and/or eliminate unavailable dead zones of proximity data. In another embodiment system 10 is used with at least two wireless communication devices sensors trying to connect to many electronic devices around it, with dead zones becoming larger and the wireless communication device 30 being overloaded without an ability to connect to all electronic devices and not significantly hinder proximity data collection. The Universal ID is broadcast and the first and second wireless communication devices 30 is always being sensed.

In one embodiment the first wireless communication device 30 scans and connects, while the second wireless communication device 30 only scans so that while the first wireless communication device 30 is in the connecting mode, the second wireless communication device 30 is still picking up the proximity data so that no data is lost during wireless communication device normal operations.

In one embodiment the first wireless communication device 30 is a BLE radio 30 and the second radio 30 is WiFi direct wireless communication device 30 such that as the BLE radio 30 is connecting the WiFi radio 30 collects proximity information such that there are no dead zones.

As a non-limiting example, the two wireless communication devices 30 are calibrated such that their relative proximities to electronic devices around them are known and adjusted such that both wireless communication devices 30 see the same proximity of electronic devices nearby.

As a non-limiting example, the two wireless communication devices 30 interface with each other such that RSSI proximity data can be merged and processed. As a non-limiting example, the proximity is 100 meters or less.

As a non-limiting example, thirty people all walk through a door when it is necessary to collect RSSI proximity data for thirty people at all time, and at the same time all thirty people have electronic devices are connected in order to obtain their information that is collected, in a manner similar to Example 9, to a Universal ID sensor. This is achieved without losing RSSI information while they are being connected such that doors systems can act to unlock a door at the right proximity to allow any of the identified thirty persons to access without losing RSSI information to determine when a proximity threshold was crossed by any number of these thirty people.

In one embodiment the Universal ID eliminates the use of credit card information in the physical space. As a non-limiting example, payments are based on the entities, more particularly, the entities Universal ID.

In one embodiment, system 10 provides Universal ID's to electronic devices resulting in a bearer of a card/cash model does not associated credit cards, cash, and the like. Instead an identity model is provided with a corresponding account for back-end and cloud-based translations to take place.

As a non-limiting example an entities Universal ID signal universal identity signal allows merchants, devices, and anything requiring a financial transfer of funds in the physical world to detect and verify the entities Universal ID identity and authenticity. As non-limiting examples, this can be achieved through coupling of biometric identifiers, including but not limited to voice and face recognition. Once identification has been established, and both the first and second entities agree to make information available for each other for an agreed transaction to take place, a transaction can take place simply by the first entity taking an item with them or by the first entity asking a merchant and the like for the item and in both cases these items are tagged and recorded on a mutually agreed ledger. As a non-limiting example, the ledger can be on a blockchain.

Once this agreed ledger of items the first entity desires to transact on is established, the actual payment transaction can take place offline via the back-end or cloud such that no payment, account or personal information is exposed in the physical environment. Instead a one-time, unique token encapsulates the agreed ledger and identification of both the first and second entities are captured and processed in the physical world, thereby limiting potentials for hackers to steal an entities credit information or account information. Transactions are then cleared at the back-end or cloud separately such that both the first and second entities are debited/deposited which can take place via traditional means, including but not limited to ACH bank account transfers, wires and the like, or via modern digital currency transactions such as through bitcoins or other cryptocurrencies, and the like.

The use of the Universal ID for payments enables merchants and people to establish a pre-arranged tab, similar to say a bar tab, whereby the first entity can without friction make many purchase transactions and not be limited by having to present payment card information every time. As a non-limiting example an entity can walk into a cafe, ask for the usual, take their coffee, and walk out. Payment is followed automatically in the back-end or cloud. As a non-limiting example, a first entity can walk into a grocery store, pick out all the items to purchase, put the items in a card, and just leave the store. The items in the cart can be sensed via other means, and the payment transaction happens automatically in the back-end or cloud.

This system and method removes the need of a Point of Sale system or checkout person though identification of shoppers or customers via the Universal ID system, coupled with sensing or recording of items requested (such as asking for a coffee) or items selected (such as taking an item off the shelf and putting it into a cart or basket) such that identities and items being served are recorded in digital form (such as via camera recording or voice recording, an electronic ledger and such) so that payments for these items can take place over the cloud (through pre-arranged accounts) thereby removing any check-out processing in the physical space.

Turning ahead in the drawings, FIG. 13 illustrates a block diagram of a system 1000, all or portions of which can be employed for electronic device payments, including but not limited to the electronic devices listed above such as: mobile electronic device; neural links that lay on your brain; neural links coupled to a processor, server, wearable devices; a human microchip implant that can be an identifying integrated circuit device or RFID transponder, and the like. System 1000 is merely exemplary and embodiments of the system are not limited to the embodiments presented herein. The system can be employed in many different embodiments or examples not specifically depicted or described herein. In some embodiments, certain elements or modules of system 1000 can perform various procedures, processes, and/or activities. In other embodiments, the procedures, processes, and/or activities can be performed by other suitable elements or modules of system 1000.

In some embodiments, system 1000 can include a retailer payment system 1050. Retailer payment system 1050 can be a computer system, and can be a single computer, a single server, or a cluster or collection of computers or servers, or a cloud of computers or servers. In various embodiments, retailer payment system 1050 can be used by a retailer for fully or partially process transactions made through one or more eCommerce websites and/or at physical (“brick and mortar”) stores. In various embodiments, when a customer purchases or choses to “check out” a virtual shopping cart on the retailer's eCommerce website, retailer payment system 1050 can process the payment for the transaction. As an example, retailer payment system 1050 can process one or more credit cards, one or more gift cards, one or more online payment accounts (such as PayPal), and/or other suitable online payment methods. In a number of embodiments, retailer payment system 1050 can store the payment methods used by customers on the eCommerce website.

In several embodiments, retailer payment system 1050 can allow customers to setup payment methods without processing a transaction. For example, a customer can enter a payment method, such as a credit card account, without processing a transaction, so that the information will be stored in retailer payment system 1050 for ready access in the future. In many embodiments, retailer payment system 1050 can store these payment methods in an account for each customer. In several embodiments, a customer can have a login username and password to access the account online and to setup payment information and/or process online payments.

In various embodiments, the retailer can have one or more physical stores, such as retail store. In many embodiments, retail store can include one or more point-of-sale (POS) systems, such as POS system 1040. In many embodiments, POS system 1040 can be used to “check out” a customer from a retail store, which can include determining which items the customer desires to purchase, determining the total purchase price for those items, and processing payment for the total purchase price. In many embodiments, POS system 1040 can process payments through cash, check, payment cards (e.g., credit cards, debit cards, gift cards, etc.), and/or other suitable payment methods.

In a number of embodiments, POS system 1040 can include a scanner 1041 and/or a keypad 1042. In many embodiments, scanner 1041 can be an optical scanner, such as a barcode reader, which can be used to scan barcodes, such as Universal Product Code (UPC) barcodes on products, and/or barcodes on coupons, gift cards, etc. In many embodiments, keypad 1042 can be used to enter numeric or alphanumeric codes, such as numeric or alphanumeric codes corresponding to barcodes on products, coupons, gift cards, etc.

In many embodiments, POS system 1040 can process a check-out transaction using a traditional gift card, which can be a physical payment card that was purchased for a predetermined amount or an amount determined upon purchasing the gift card. In some embodiments, gift cards can be “reloaded,” such as by adding funds to an existing gift card. In many embodiments, virtual gift cards can be purchased online and used for eCommerce purchases, and can be similar to a traditional physical gift card. In a number of embodiments, physical gift cards and/or virtual gift cards can be used for in-store and/or eCommerce purchases. In many embodiments, the POS system 1040 and/or retailer payment system 1050 can process the physical and/or virtual gift cards based on a unique identifier that identifies each gift card account.

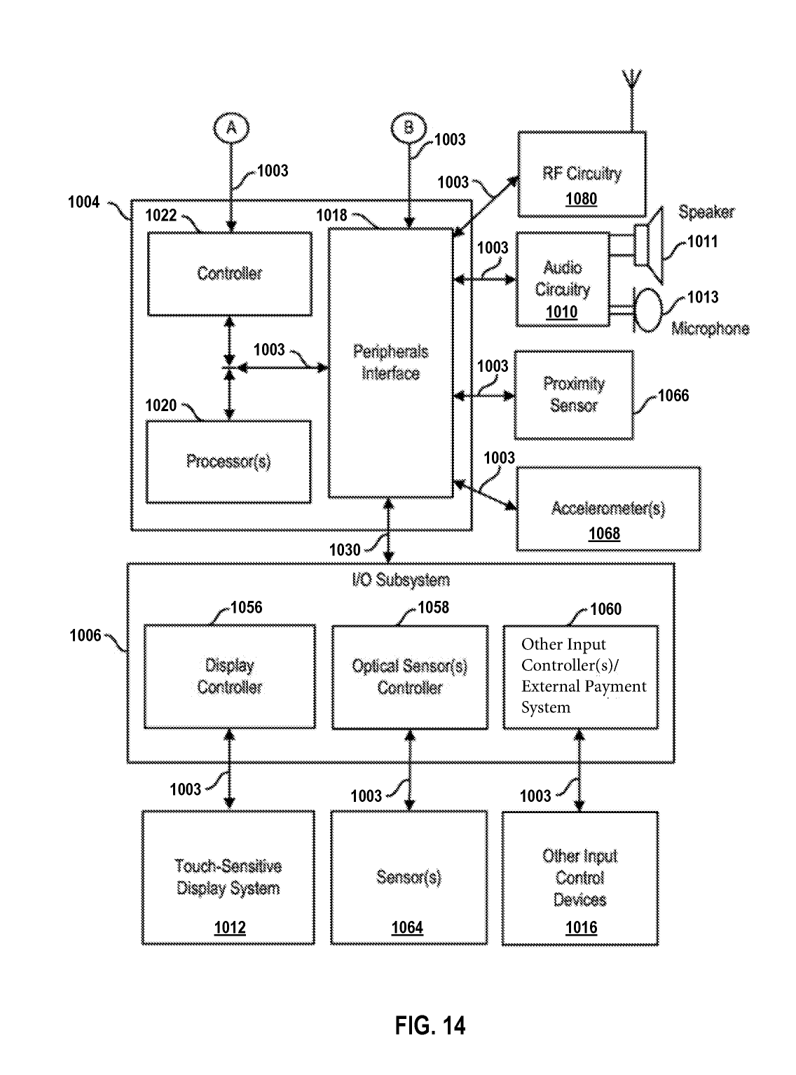

In several of embodiments, retailer payment system 1050 and/or POS system 1040 can be in data communication with one or more external payment systems, such as external payment system 1060, as illustrated in FIG. 14. External payment system 1060 can be a computer system, such as computer system 10 (FIG. 1), as described above, and can be a single computer, a single server, or a cluster or collection of computers or servers, or a cloud of computers or servers. In many embodiments, external payment system can be operated by one or more entities different from the retailer, and can handle payment processing for various payment cards, such as credit cards, debit cards, etc. For example, in some embodiments, external payment system 1060 can include a system for an acquiring (merchant/retailer) bank, a payment card system, and a system for an issuing (cardholder) bank, as is generally used in conventional credit card transactions. In a number of embodiments, external payment system 1060 can be a payment system for online payment accounts, such as PayPal. In many embodiments, when a customer presents POS system 1040 with a payment card, POS system 1040 can communicate with external payment system 1060 to process the payment card. In some embodiments, when the customer presents POS system 1040 with a payment card, POS system 1040 can communicate with retailer payment system 1050, which in turn can communicate with external payment system 1060 to process the payment card.

It is to be understood that the present disclosure is not to be limited to the specific examples illustrated and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims. Accordingly, parenthetical reference numerals in the appended claims are presented for illustrative purposes only and are not intended to limit the scope of the claimed subject matter to the specific examples provided in the present disclosure.

What is claimed is:

1. A method of conducting an interaction between a first entity and a second entity, comprising:
providing a Universal ID system that includes a front end with a transmitter, a receiver coupled to the transmitter and at least one passive filter coupled to the transmitter;
coupling the front-end to at least one of a back-end or a cloud system, each of the back-end and the cloud system including: storage; server; a Universal ID character generator device that generates portions of the Universal ID; and
in response to an interaction between the first entity and a second entity transmitting by the transmitter a signal for all or a portion of a first entity Universal ID that includes non-permanent IDs and permanent IDs, the Universal ID including biometric identifiers of the first entity, the signal including a plurality authentications with identifiers, each of an authentication associated with a different second entity, the first party Universal ID being used with a plurality of electronic devices that each have a different first entity authentication from the Universal ID with each of a different electronic device requiring a first entity authentication to gain access to each of an electronic device of the plurality of electronic devices, wherein the signal provides an authentication of the Universal ID to a second entity and is done passivity where the first entity takes no action for the first entity Universal ID signal to be emitted, and for an interaction to be sensed and acted on by an action, in response to the interaction the second entity creates an action that causes a physical change in a hardware component of a second entity electronic device.

2. The method of claim 1, wherein the biometric identifiers that are distinctive, measurable characteristics used to label and describe the first entity.

3, The method of claim 1, wherein biometric identifiers include identifiers that can be both physiological and behavioral characteristics.

4. The method of claim 3, wherein the physiological characteristic is related to a shape of the first entity.

5. The method of claim 4, wherein the physiological characteristics are selected from at least one of: fingerprint, palm veins, face recognition, DNA, palm print, hand geometry, iris recognition, retina, and odor/scent.

6. The method of claim 3, wherein the behavioral biometric identifiers are related to the pattern of behavior of the first entity.

7. The method of claim 6, wherein the behavioral biometric identifiers are selected from at least one of: typing rhythm, gait, voice, and gestures

8. The method of claim 1, wherein the Universal ID layered with biometric identifiers senses the first entities physical presence and identifies that entity passively in a physical environment.

9. The method of claim 1, wherein the biometric identifiers are not stored on a local or centralized server.

10. The method of claim 1, wherein the biometric identifiers are not stored at a local database.

11. The method of claim 1, wherein the first entities physical presence is sensed and identification of that entity is done passively in the physical environment.

12. The method of claim 1, wherein the biometric identifiers are selected from facial recognition and voice, and are identified by a camera or microphone.

13. The method of claim 1, wherein the first entities biometric identifiers are stored on a first entities personal electronic device.

14. The method of claim 13, wherein the first entities personal electronic device is a mobile device.

15. The method of claim 13, wherein the first entities personal electronic device is a wearable device.

16. A method of conducting an interaction between a first entity and a second entity, comprising:
providing a Universal ID system that includes a front end with a transmitter, a receiver coupled to the transmitter and at least one passive filter coupled to the transmitter;
coupling the front-end to at least one of a back-end or a cloud system, each of the back-end and the cloud system including: storage; server; a Universal ID character generator device that generates portions of the Universal ID; and
in response to an interaction between the first entity and a second entity transmitting by the transmitter a signal for all or a portion of a first entity Universal ID, the Universal ID including biometric identifiers of the first entity, the signal including a plurality authentications with identifiers, each of an authentication associated with a different second entity, the first party Universal ID being used with a plurality of electronic devices that each have a different first entity authentication from the Universal ID with each of a different electronic device requiring a first entity authentication to gain access to each of an electronic device of the plurality of electronic devices, in response to the interaction the second entity creates an action that causes a physical change in a hardware component of a second entity electronic device, wherein the first entity Universal ID signal is sensed passively, decoded in a background and provided by the second entity, recognized and authenticated without requiring dedicated secure element hardware within the first or the second entity.

17. The method of claim 16, wherein the biometric identifiers that are distinctive, measurable characteristics used to label and describe the first entity.

18, The method of claim 16, wherein biometric identifiers include identifiers that can be both physiological and behavioral characteristics.

19. The method of claim 18, wherein the physiological characteristic is related to a shape of the first entity.

20. The method of claim 19, wherein the physiological characteristics are selected from at least one of: fingerprint, palm veins, face recognition, DNA, palm print, hand geometry, iris recognition, retina, and odor/scent.

21. The method of claim 19, wherein the behavioral biometric identifiers are related to the pattern of behavior of the first entity.

22. The method of claim 21, wherein the behavioral biometric identifiers are selected from at least one of: typing rhythm, gait, voice, and gestures

23. The method of claim 16, wherein the Universal ID layered with biometric identifiers senses the first entities physical presence and identifies that entity passively in a physical environment.

24. The method of claim 16, wherein the biometric identifiers are not stored on a local or centralized server.

25. The method of claim 16, wherein the biometric identifiers are not stored at a local database.

26. The method of claim 16, wherein the first entities physical presence is sensed and identification of that entity is done passively in the physical environment.

27. The method of claim 16, wherein the biometric identifiers are selected from facial recognition and voice, and are identified by a camera or microphone.

28. The method of claim 16, wherein the first entities biometric identifiers are stored on a first entities personal electronic device.

29. The method of claim 28, wherein the first entities personal electronic device is a mobile device.

30. The method of claim 28, wherein the first entities personal electronic device is a wearable device.
